(19) United States
(12) Patent Application Publication
(10) Pub. No.: US 2026/0149755 A1
(43) Pub. Date: May 28, 2026

(54) DYNAMIC SEGMENTATION SYSTEM

(71) Applicant: Reltio, Inc., Redwood Shores, CA (US)

(72) Inventors: Abhradeep Sengupta, Bengaluru (IN); Karthik Thomas, Bengaluru (IN); Sri Charan Gontla, Markapur (IN); Anshuman Kanwar, Cambridge, MA (US)

(21) Appl. No.: 19/397,918

(22) Filed: Nov. 22, 2025

Related U.S. Application Data
(60) Provisional application No. 63/724,270, filed on Nov. 22, 2024.
(60) Provisional application No. 63/758,283, filed on Feb. 13, 2025.

(51) Int. Cl. H04L 67/50; G06F 16/9032; G06F 16/9038

(52) U.S. Cl. CPC H04L 67/535; G06F 16/9032; G06F 16/9038

(57) ABSTRACT

Receiving, by a multi-tenant platform, a segment query, wherein the segment query includes static attributes and dynamic attributes, wherein the dynamic attributes include interaction data. Executing, by the multi-tenant platform, the segment query. Receiving, by the multi-tenant platform in response to the execution of the segment query, a segment result set, wherein the segment result set comprises a segment of a population of a tenant of the multi-tenant platform. Automatically synchronizing, by the multi-tenant platform in response to receiving the segment result set, the segment result set with one or more third-party systems. Triggering, in response to the automatic synchronization, the one or more third-party systems to perform one or more campaign actions of a campaign using the segment included in the segment result set. Storing the segment query. Receiving updated data for the static attributes and the dynamic attributes. Re-executing, either periodically or on-demand, the stored segment query using the updated data for the static attributes and the dynamic attributes. Receiving, by the multi-tenant platform in response to the re-execution of the stored segment query, a second segment result set, wherein the second segment result set comprises a second segment of the population of the tenant of the multi-tenant platform. Automatically synchronizing, by the multi-tenant platform in response to receiving the second segment result set, the second segment result set with the one or more third-party systems. Triggering, in response to the automatic synchronization, the one or more third-party systems to perform one or more second campaign actions using the second segment included in the second segment result set.

### CROSS-REFERENCE TO RELATED APPLICATIONS

The present application claims priority to U.S. Provisional Patent Application Ser. No. 63/758,283 filed Feb. 13, 2025 and entitled “Dynamic Segmentation System,” and to U.S. Provisional Patent Application Ser. No. 63/724,270 filed Nov. 22, 2024 and entitled “Connected Data Platform,” each of which is incorporated by reference herein.

### BRIEF DESCRIPTION OF THE DRAWINGS

FIG. 1 depicts a diagram of an example connected data platform.

FIG. 2 depicts a diagram of an example environment for an integration hub system.

FIG. 3 depicts a diagram of an example three-layer model.

FIG. 4 depicts a diagram of some examples of entity type, relationship type and event metadata.

FIG. 5 depicts a flowchart of an example of a method of dynamic matching facilitation.

FIG. 6 depicts a diagram of an example machine learning vectorization system.

FIGS. 7A-B depicts diagrams of example vector relationships with different vector relationship closeness thresholds.

FIG. 8 depicts a flowchart of an example method of vectorization for dynamic blocking.

FIG. 9 depicts a flowchart of an example method of vectorization for anomaly detection.

FIG. 10 depicts a diagram of an example network environment for dynamic audience segmentation and intelligent agents.

FIG. 11 depicts a diagram of an example dynamic segmentation system that facilitates personalized campaigns and experiences, next best actions, and proactive retention strategies, to name a few examples.

FIG. 12 depicts a flowchart of an example method of dynamic segmentation.

FIG. 13 depicts a flowchart of an example method of machine learning-based dynamic segmentation.

FIG. 14 depicts a diagram of an example intelligent agent plugin system.

FIG. 15 depicts a dynamic matching facilitation flowchart.

FIG. 16 depicts a dynamic matching flowchart.

FIG. 17 depicts a high-level flowchart for MatchIQ.

FIG. 18 depicts a flowchart for configuring survivorship within an example User Interface (UI).

FIG. 19 depicts a flowchart of an example of a method of cross-tenant matching and lineage EID promotion.

### DETAILED DESCRIPTION

A claimed solution rooted in computer technology overcomes problems specifically arising in the realm of computer technology. In various embodiments, a computing system (e.g., a multi-tenant platform with a dynamic segmentation system) is configured to receive a segment query. The segment query may include static attributes and dynamic attributes. The dynamic attributes may include interaction data. The computing system can execute the segment query to generate a segment result set. The segment result set may include a segment of a population of a tenant of the computing system. The computing system can automatically synchronize (e.g., in response to receiving the segment result set) the segment result set with third-party applications and/or systems (collectively, systems). The computing system can trigger (e.g., in response to the automatic synchronization) the third-party systems to perform campaign actions (e.g., deployment of a software update) of a campaign (e.g., software deployment campaign) using the segment included in the segment result set. The computing system can also store the segment query (e.g., for re-execution).

In some embodiments, the computing system can receive updated data for the static attributes and the dynamic attributes, and re-execute (e.g., periodically or on-demand) the stored query with the updated data. For example, the computing system can receive (e.g., in response to the re-execution of the stored segment query) a second segment result set. The second segment result set may include a second segment of the population of the tenant of the multi-tenant platform. The computing system can automatically synchronize (e.g., in response to receiving the second segment result set) the second segment result set with the one or more third-party systems. The computing system can then trigger (e.g., in response to the automatic synchronization) the one or more third-party systems to perform one or more other campaign actions (e.g., deployment of another software update) using the second segment included in the second segment result set.

In various embodiments, a computing system (e.g., a multi-tenant platform with a dynamic segmentation system) is configured to generate and/or obtain one or more domain-specific machine learning models. The computing system can also obtain static attribute data and dynamic attribute data. The computing system can then predict, using the one or more domain-specific machine learning models and the static attribute data the dynamic attribute data, a response likelihood of one or more entities of a population of a tenant of the computing system. The computing system can then generate a segment query that can include static attributes and dynamic attributes. For example, the dynamic attributes may include interaction data and the predicted response likelihood of the one or more entities (or, members) of the population of the tenant. The computing system can then execute the segment query and obtain a segment result set in response to execution of the segment query. The segment result set may include a segment of a population of a tenant. The computing system can further automatically synchronize, in response to receiving the segment result set, the segment result set with one or more third-party systems, and trigger the one or more third-party systems to perform one or more campaign actions, such as transmitting one or more electronic messages (e.g., emails) to the segment included in the segment result set.

In various embodiments, a computing system is configured to ingest data from a variety of different data sources. For example, the computing system may ingest enterprise data from different tenants of the computing system. The computing system can convert the data into a plurality of vectors (or, “vectorize” the data). Accordingly, each vector represents a portion of the data (e.g., an object of the data). This vectorization allows the computing system to perform a variety of different functions (e.g., dynamic blocking, anomaly detection, and semantic matching) that improve computational efficiency (e.g., reduced memory requirements, reduced processing requirements, reduced bandwidth requirements, etc.) while also maintaining or improving computational accuracy (e.g., matching accuracy). More specifically, the computing system can compare the vectors with each other and determine distances between the plurality of vectors based on the comparison. The computing system can receive a query, and automatically determine a set of candidate matches based on the query and the determined distances between the vectors based on the comparison (e.g., shorter distances can indicate closer relationships than longer distances). This can, for example, remove the need for a user (e.g., subject matter expert) to manually create or edit a set of candidate matches. The computing system can then resolve the query based on matching one or more portions of the query with the set of candidate matches.

In various embodiments, the computing system can obtain an input (e.g., a query) and determine an anomaly score for the input based on the determined distances between the plurality of vectors. The computing system can obtain an anomaly threshold value from a plurality of threshold values and compare the anomaly score and the anomaly threshold value. The computing system can trigger notification based on the comparison of the of anomaly score and the anomaly threshold value.

In various embodiments, a computing system is configured to identify matching data records within a set of data records and merge the matching data records. Using the entity resolution request, the computing system can identify attributes in a data model. The computing system can then identify other attributes in the data model and/or other data models.

In various embodiments, a unique architecture enables efficient modelling of entities, relationships, and interactions that typically form the basis of a business. These models enable insights, scalability, and management not previously available in the prior art. It will be appreciated that with the information model discussed herein, there is no need to consider tables, foreign keys, or any of the low-level physicality of how the data is stored.

An information model may be utilized as a part of a multi-tenant platform. In a specific implementation, a configuration sits in a layer on top of the RELTIO™ platform and natively enjoys capabilities provided by the platform such as matching, merging, cleansing, standardization, workflow, and so on. Entities established in a tenant may be associated with custom and/or standard interactions of the platform. The ability to hold and link three kinds of data (i.e., entities, relationships, and interactions) in the platform and leverage the confluence of them in one place provides unlimited power to model and understand a business.

In various embodiments, the metadata configuration is based on an n-layer model. One example is a 3-layer model (e.g., which is the default arrangement). In some embodiments, each layer is represented by a JSON file (although it will be appreciated that many different file structures may be utilized such as BSON or YAML).

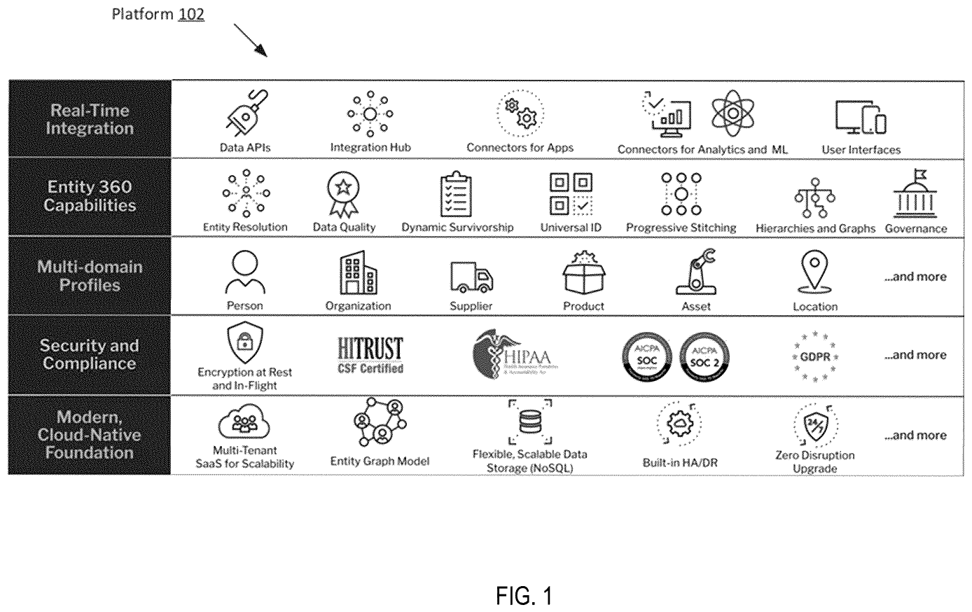

The information models may be utilized as a part of a connected, multi-tenant system. FIG. 1 depicts a multi-tenant platform 102 (or, simply, platform 102). The platform 102 enables seamless scaling in many operational or analytical use case. The platform 102 may be the foundation of master data management (MDM). Various integration options, including a low-code/no-code solution, allow rapid deployment and time to value.

FIG. 1 is an example of functions of the platform 102 in some embodiments. The platform 102 may support best in class MDM capabilities, including identity resolution, data quality, dynamic survivorship for contextual profiles, universal ID across all your operational applications and hierarchies, knowledge graph to manage relationships, progressive stitching to create richer profiles, and governance capabilities. Further, the platform 102 may support high volume transactions, high volume API calls, sophisticated analytics, and back-end jobs for any workload in an auto-scaling cloud environment. As follows, the platform 102 may support high redundancy, fault tolerance, and availability with built-in NoSQL database, Elasticsearch, Spark, and other AWS and GCP services across multiple zones.

In various embodiments, the platform 102 is multi-domain and enables seamless integration of many types of data and from many sources to create master profiles of any data entity—person, organization, product, location. Users can create master profiles for consumers, B2B customers, products, assets, sites, and connect them to see the complete picture.

The platform 102 may enable API-first approach to data integration and orchestration. Users (e.g., tenants) can use APIs, and various application-specific connectors to ease integration. Additionally, in some embodiments, users can stream data to analytics or data science platforms for immediate insights.

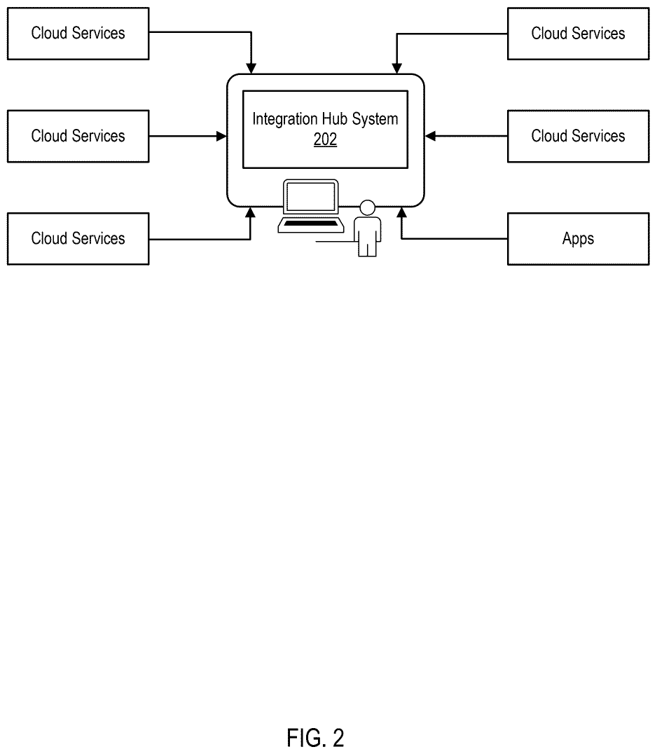

FIG. 2 depicts an environment for an integration hub system 202. The integration hub system 202 may connect various data sources and downstream consumers. In some embodiments, the integration hub system 202 comes with over 1,000 connectors to build data pipelines right. The integration hub system 202 may include an intuitive drag-and-drop graphical interface to create simple replication pipelines to complex data extraction and transformation tasks. With pre-built community recipes for common use cases, users can set up integration workflows in just a few clicks.

Along with the built-in data loader, event streaming capabilities, data APIs, and partner connectors, the integration hub system 202 enables rapid links to user systems using the platform 102. The integration hub system 202 may enable users to build automated workflows to get data to and from the platform 102 with any number of SaaS applications in just hours or days. Faster integration enables faster access to unified, trusted data to drive real-time business operations.

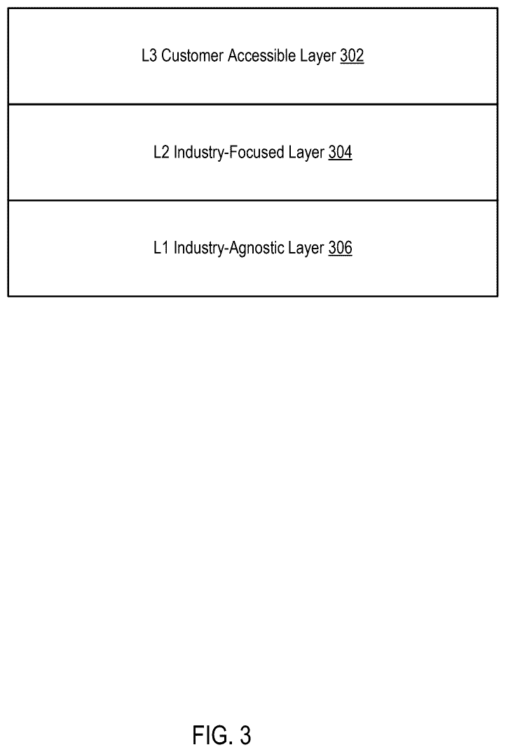

FIG. 3 depicts a three-layer model in some embodiments. Of the three layers, only layer 3 (e.g., the top layer of the n-layer model) 302, known as the “L3” is accessible by the customer. It is the layer that is a part of a tenant. The information associated with the L3 layer 302 may be retrieved from the tenant, edited. and applied back to the tenant using Configuration API.

The L3 302 layer typically inherits from the L2 layer 304 (an industry-focused layer) which in turn inherits from the L1 layer 306 (An industry-agnostic layer). Usually, the L3 layer 302 refers to an L2 304 container and inherits all data items (or “objects”) from the L2 304 container. However, it is not required that the L3 302 refer to the L2 304 container, it can standalone.

The L2 layer 304 may inherit the objects from the L1 layer. Whereas there is only a single L1 306 set of objects, the objects at the L2 layer 304 may be grouped into industry-specific containers. Like the L1 layer 306, the containers at the L2 layer 304 may be controlled by product management and may not be accessible by customers.

Life sciences is a good example of an L2 layer 304 container. The L2 layer 304 container 304 may inherit the Organization entity type (discussed further herein) from L1 layer 306 and extends it to the Health Care Organization (HCO) type needed in life sciences. As such, the HCO type enjoys all of the attribution and other properties of the Organization type, but defines additional attributes and properties needed by an HCO.

The L1 layer 306 may contain entities such as Party (an abstract type) and Location. In some embodiments, the L1 layer 306 contains a fundamental relationship type called HasAddress that links the Party type to the Location type. The L1 layer 306 also extends the Party type to Organization and Individual (both are non-abstract types).

There may be only one L1 layer 306, and its role is to define industry-agnostic objects that can be inherited and utilized by industry specific layers that sit at the L2 layer 304. This enables enhancement of the objects in the L1 layer 306, potentially affecting all customers. For example, if an additional attribute was added into the HasAddress relationship type, it typically would be available for immediate use by any customer of the platform.

Any object can be defined in any layer. It is the consolidated configuration resulting from the inheritance between the three layers that is commonly referred to as the tenant configuration or metadata configuration. In a specific implementation, metadata configuration consolidates simple, nested, and reference attributes from all the related layers. Values described in the higher layer overrides the values from the lower layers. The number of layers does not affect the inheritance.

In a specific implementation, metadata configuration consolidates simple, nested, and reference attributes from all the related layers. Values described in the higher layer overrides the values from the lower layers. The number of layers does not affect the inheritance.

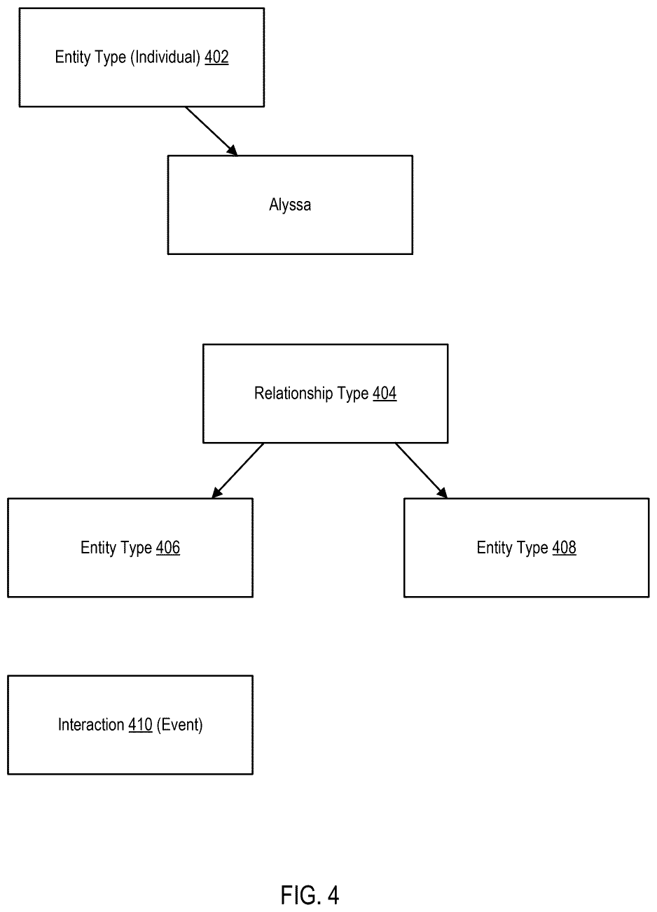

FIG. 4 is a box diagram of some examples of entity type, relationship type and event metadata. The platform 102 enables object types entities, relationships, and interactions. The entity type 402 may be a class of entity. For example, “Individual” is an entity type 402, and “Alyssa” represents a specific instance of that entity type. Other common examples of entity types include “Organization,” “Location,” and “Product.”

Often, entity types can materialize in single instances, such as the “Alyssa” example above. In another example, the L1 layer may define the abstract “Party” entity type with a small collection of attributes. The L1 layer may then be configured to define the “Individual” entity type and the “Organization” entity type, both of which inherit from “Party,” both of which are non-abstract and both of which add additional attributes specific to their type and business function. Continuing with the concept of inheritance, in the L2 Life Sciences container, the HCP entity may be defined (to represent physicians) which inherits from the “Individual” type but also defines a small collection of attributes unique to the HCP concept. Thus, there is an entity taxonomy “Party,” “Individual,” or “HCP,” and the resulting HCP entity type provides the developer and user with the aggregate attribution of “Party,” “Individual,” and “HCP.”

Once the entity types are defined, the user can link entities together in a data model by using the relationship type. Once the user defines entity types, they can be linked by defining relationships between them. For example, a user can post a relationship independently to link two entities together, or the client can mention a relationship in a JSON, which then posts the relationship and the two entities all at once.

A relationship type 404 describes the links or connections between two specific entities (e.g., entities 406 and 408). A relationship type 404 and the entities 406 and 408 described together form a graph. Some common relationship types are Organization to Organization, Subsidiary Of, Partner Of, Individual to Individual, Parent of/Child Of, Reports To, Individual to Organization/Organization to Individual, Affiliated With, Employee Of/Contractor Of.

Once the user defines entity types, they can be linked by defining relationships between them. For example, a user can post a relationship independently to link two entities together, or the client can mention a relationship in a JSON, which then posts the relationship and the two entities all at once.

The platform 102 may enable the user to define metadata properties and attributes for relationship types. The user can define up to any number metadata properties. The user can also define several attributes for a relationship type, such as name, description, direction (undirected, directed, bi-directional), start and end entities, and more. Attributes of one relationship type can inherit attributes from other relationship types.

Hierarchies may be defined through the definition of relationship subtypes. For example, if a user defines “Family” as a relationship type, the user can define “Parent” as a subtype. One hierarchy contains one or many relationship types; all the entities connected by these relationships form a hierarchy. Entity A>HasChild (Entity B)>HasChild (Entity C). Then A, B, and C form a hierarchy. In the same hierarchy, the user can add Subsidiary as a relationship and if Entity D is subsidiary of Entity C, then A, B, C, and D all become part of a single hierarchy.

Interactions 410 are lightweight objects that represent any kind of interaction or transaction. As a broad term, interaction 410 stands for an event that occurs at a particular moment such as a retail purchase or a measurement. It can also represent a fact in a period of time such as a sales figure for the month of June.

Interactions 410 may have multiple actors (entities), and can have varying record lengths, columns, and formats. The data model may be defined using attribute types. As a result, the user can build a logical data model rather than relying on physical tables and foreign keys; define entities, relationships, and interactions in granular detail; make detailed data available to content and interaction designers; provide business users with rich, yet streamlined, search and navigation experiences.

In various embodiments, four manifestations of the attribute type include Simple, Nested, Reference, and Analytic. The simple attribute type represents a single characteristic of an entity, relationship, or interaction. The nested, reference and analytic attribute types represent combinations or collections of simple sub-attribute types.

The nested attribute type is used to create collections of simple attributes. For example, a phone number is a nested attribute. The sub-attributes of a phone number typically include Number, Type, Area code, Extension. In the example of a phone number, the sub-attributes are only meaningful when held together as a collection. When posted as a nested attribute, the entire collection represents a single instance, or value, of the nested attribute. Posts of additional collections are also valid and serve to accumulate additional nested attributes within the entity, relationship or interaction data type.

The reference attribute type facilitates easy definition of relationships between entity types in a data model.

A user may utilize the reference attribute type when they need one entity to make use of the attributes of another entity without natively defining the attributes of both. For example, the L1 layer in the information model defines a relationship that links an Organization and an Individual using the affiliatedwith relationship type. The affiliatedwith relationship type defines the Organization entity type to be a reference attribute of the Individual entity type. This approach to data modeling enables easier navigation between entities and easier refined search.

Easier navigation between entities: In the example of the Organization and Individual entities that are related using the affiliatedwith relationship type, specifying an attribute of previous employer for the Individual entity type enables this attribute to be presented as a hyperlink on the individual's profile facet. From there, the user can navigate easily to the individual's previous employer.

Easily refined search: When attributes of a referenced entity and relationship type are available to be indexed as though they were native to the referencing entity, business users can more easily refine search queries. For example, in a search of a data set that contains 100 John Smith records, entering John Smith in the search box will return 100 John Smith records. Adding Acme to the search criteria will return only those records with John Smith that have a reference, and thus an attribute, that contains the word Acme.

The analytic attribute type is lightweight. In various embodiments, it is not managed in the same way that other attributes are managed when records come together during a merge operation. The analytic attribute type may be used to receive and hold values delivered by an analytics solution.

The user may utilize the analytic attribute type when they want to make a value from your analytics solution, such as Reltio Insights, available to a business user or to other applications using the Reltio Rest API. For example, if an analytics implementation calculates a customer's lifetime value and the user needs that value to be available to the user while they are looking at the customer's profile, the user may define an analytic attribute to hold this value and provide instructions to deliver the result of the calculation to this attribute.

In a specific implementation, the platform 102 assigns entity IDs (EIDs) to each item of data that enters the platform. As such, the platform can appropriately be characterized as including an EID assignment engine. Importantly, a lineage-persistent relational database management system (RDBMS) retains the EIDs for each piece of data, even if the data is merged and/or assigned a new EID. As such, the platform can appropriately be characterized as including a legacy EID retention engine, which has the task of ensuring when new EIDs are assigned, legacy EIDs are retained in a legacy EID datastore. The legacy EID retention engine can at least conceptually be divided into a legacy EID survivorship subengine responsible for retaining all EIDs that are not promoted to primary EID as legacy EIDs and a lineage EID promotion subengine responsible for promoting an EID of a first data item merged with a second data item to primary EID of the merged data item. An engine responsible for changing data items, including merging and unmerging (previously merged) data items can be characterized as a data item update engine. Cross-tenant durability also becomes possible when legacy EIDs are retained. In a specific implementation, a cross-tenant durable EID lineage-persistent RDBMS has an n-Layer architecture, such as a 3-Layer architecture.

Data may come from multiple sources. The process of receiving data items can be referred to as “onboarding” and, as such, the platform 102 can be characterized as including a new dataset onboarding engine. Each data source is registered and, in a specific implementation, all data that is ultimately loaded into a tenant will be associated with a data source. If no source is specified when creating a data item (or “object”), the source may have a default value. As such, the platform can be characterized as including an object registration engine that registers data items in association with their source.

A crosswalk can represent a data provider or a non-data provider. Data providers supply attribute values for an object and the attributes are associated with the crosswalk. Non-data providers are associated with an overall entity (or relationship); it may be used to link an L1 (or L2) object with an object in another system. Crosswalks do not necessarily just apply to the entity level; each supplied attribute can be associated with data provider crosswalks. Crosswalks are analogous to the Primary Key or Unique Identifier in the RDBMS industry.

The engines and datastores of the platform 102 can be connected using a computer-readable medium (CRM). A CRM is intended to represent a computer system or network of computer systems. A “computer system,” as used herein, may include or be implemented as a specific purpose computer system for carrying out the functionalities described in this paper. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

Memory of a computer system includes, by way of example but not limitation, random access memory (RAM), such as dynamic RAM (DRAM) and static RAM (SRAM). The memory can be local, remote, or distributed. Non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. During execution of software, some of this data is often written, by a direct memory access process, into memory by way of a bus coupled to non-volatile storage. Non-volatile storage can be local, remote, or distributed, but is optional because systems can be created with all applicable data available in memory.

Software in a computer system is typically stored in non-volatile storage. Indeed, for large programs, it may not even be possible to store the entire program in memory. For software to run, if necessary, it is moved to a computer-readable location appropriate for processing, and for illustrative purposes in this paper, that location is referred to as memory. Even when software is moved to memory for execution, a processor will typically make use of hardware registers to store values associated with the software, and a local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus of a computer system can couple a processor to an interface. Interfaces facilitate the coupling of devices and computer systems. Interfaces can be for input and/or output (I/O) devices, modems, or networks. I/O devices can include, by way of example but not limitation, a keyboard, a mouse or other pointing device, disk drives, printers, a scanner, and other I/O devices, including a display device. Display devices can include, by way of example but not limitation, a cathode ray tube (CRT), liquid crystal display (LCD), or some other applicable known or convenient display device. Modems can include, by way of example but not limitation, an analog modem, an IDSN modem, a cable modem, and other modems. Network interfaces can include, by way of example but not limitation, a token ring interface, a satellite transmission interface (e.g., “direct PC”), or other network interface for coupling a first computer system to a second computer system. An interface can be considered part of a device or computer system.

Computer systems can be compatible with or implemented as part of or through a cloud-based computing system. As used in this paper, a cloud-based computing system is a system that provides virtualized computing resources, software and/or information to client devices. The computing resources, software and/or information can be virtualized by maintaining centralized services and resources that the edge devices can access over a communication interface, such as a network. “Cloud” may be a marketing term and for the purposes of this paper can include any of the networks described herein. The cloud-based computing system can involve a subscription for services or use a utility pricing model. Users can access the protocols of the cloud-based computing system through a web browser or other container application located on their client device.

A computer system can be implemented as an engine, as part of an engine, or through multiple engines. As used in this paper, an engine includes at least two components: 1) a dedicated or shared processor or a portion thereof; 2) hardware, firmware, and/or software modules executed by the processor. A portion of one or more processors can include some portion of hardware less than all of the hardware comprising any given one or more processors, such as a subset of registers, the portion of the processor dedicated to one or more threads of a multi-threaded processor, a time slice during which the processor is wholly or partially dedicated to carrying out part of the engine's functionality, or the like. As such, a first engine and a second engine can have one or more dedicated processors, or a first engine and a second engine can share one or more processors with one another or other engines. Depending upon implementation-specific or other considerations, an engine can be centralized, or its functionality distributed. An engine can include hardware, firmware, or software embodied in a computer-readable medium for execution by the processor. The processor transforms data into new data using implemented data structures and methods, such as is described with reference to the figures in this paper.

The engines described in this paper, or the engines through which the systems and devices described in this paper can be implemented as cloud-based engines. As used in this paper, a cloud-based engine is an engine that can run applications and/or functionalities using a cloud-based computing system. All or portions of the applications and/or functionalities can be distributed across multiple computing devices and need not be restricted to only one computing device. In some embodiments, the cloud-based engines can execute functionalities and/or modules that end users access through a web browser or container application without having the functionalities and/or modules installed locally on the end-users' computing devices.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a general- or specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations, while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud based datastore is a datastore that is compatible with cloud-based computing systems and engines.

Assuming a CRM includes a network, the network can be an applicable communications network, such as the Internet or an infrastructure network. The term “Internet” as used in this paper refers to a network of networks that use certain protocols, such as the TCP/IP protocol, and possibly other protocols, such as the hypertext transfer protocol (HTTP) for hypertext markup language (HTML) documents that make up the World Wide Web (“the web”). More generally, a network can include, for example, a wide area network (WAN), metropolitan area network (MAN), campus area network (CAN), or local area network (LAN), but the network could at least theoretically be of an applicable size or characterized in some other fashion (e.g., personal area network (PAN) or home area network (HAN), to name a couple of alternatives). Networks can include enterprise private networks and virtual private networks (collectively, private networks). As the name suggests, private networks are under the control of a single entity. Private networks can include a head office and optional regional offices (collectively, offices). Many offices enable remote users to connect to the private network offices via some other network, such as the Internet.

Matching is a powerful area of functionality and can be leveraged in various ways to support different needs. The classic scenario is that of matching and merging entities (Profiles). Within the architecture discussed herein, relationships that link entities can also and often do match and merge into a single relationship. This may occur automatically and is discussed herein.

Matching can be used on profiles within a tenant to deduplicate them. It can be used externally from the tenant on records in a file to identify records within that file that match to profiles within a tenant. Matching may also be used to match profiles stored within a Data Tenant to those within a tenant.

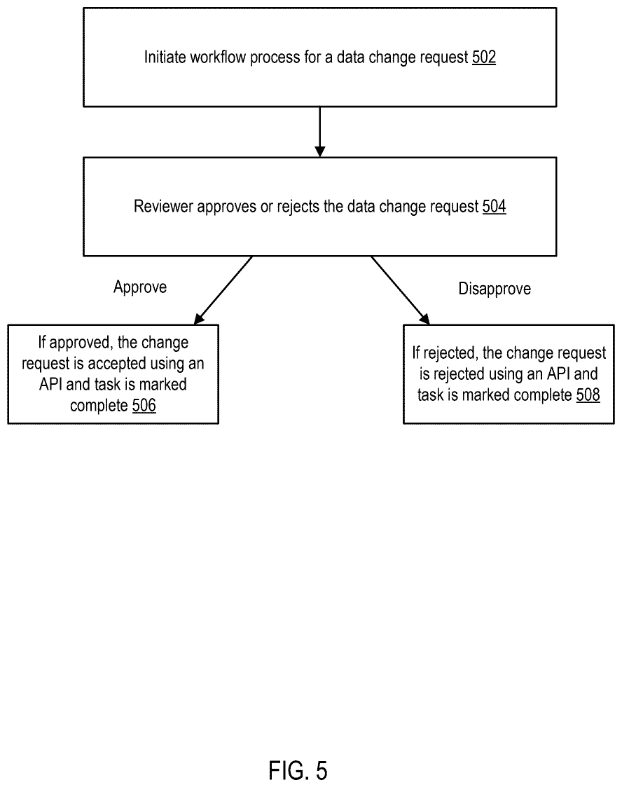

FIG. 5 depicts a flowchart of an example of a method of a dynamic matching facilitation. In this and other flowcharts, flow diagrams, and/or sequence diagrams, the flowchart illustrates by way of example a sequence of modules. It should be understood that the modules may be reorganized for parallel execution, or reordered, as applicable. Moreover, some modules that could have been included may have been removed to avoid providing too much information for the sake of clarity and some modules that were included could be removed but may have been included for the sake of illustrative clarity.

In some embodiments, a workflow is a series of sequential steps or tasks that are carried out based on user-defined rules or conditions to execute a business process. The Workflow may allow a user to manage complex business processes through a series of predetermined steps or tasks. The platform 102 may utilize the workflow to enable processes and tasks management, including the assignment and tracking of the tasks. A workflow process may support a creator, a create date, a due date, an assignee, steps, and comments. In various embodiments, workflow business processes are configurable. In some embodiments, the various actors and triggers in a workflow are Actors: The people and processes that participate in the workflow are the actors, e.g., Reviewer, Workflow Engine, Hub, and API; Reviewer: The user will be assigned with the role ROLE REVIEWER; Trigger: It is a scheduled process that scans activity logs to initiate a review workflow, e.g., from the UI, you can start a Data Change Request workflow to review the updates or the changes to the entities or the profiles data in your tenant. The workflow feature may allow a user to manage business processes through a series of predetermined steps or tasks which enables you to plan and coordinate user tasks, validations, reviews, and approvals for multiple records.

Data Change Request (DCR) is a collection of suggested data changes. Users who do not have rights to update objects, such as the customer sales representatives, can suggest changes. These suggested changes will be accumulated in Data Change Requests queued for review and approval by people with approval privileges, such as the data stewards. Examples of suggested data changes include adding a new attribute value, updating an attribute value, deleting an attribute value, and creating a new object along with referenced objects. Data Change Requests can be initiated using web browser-based user interface for Desktop or Mobile. An example of a step can be a user task assigned to users for Review and Approval of the data change request. In this example, a Workflow for a Data Change Request (DCR) includes the following sequence of steps in the flowchart of FIG. 5.

In module 502, on the profile page in Hub, users can initiate the DCR workflow process in the Suggesting mode.

In module 504, the Reviewer can Approve or Reject the DCR. In the Data Change Request Review pane of the UI, sub-attributes within the nested, reference, or complex attributes, and parent-nested attributes, have a label of the attribute value.

In module 506, if the Reviewer approves the DCR, the change request is accepted using the API and the task is marked complete.

In alternative module 508, if the Reviewer rejects the DCR, the change request is rejected using the API and the task is marked complete. In the Inbox, you have the option of partially rejecting changes from a DCR. In various embodiments, a reviewer may selectively reject attributes and approve a DCR partially.

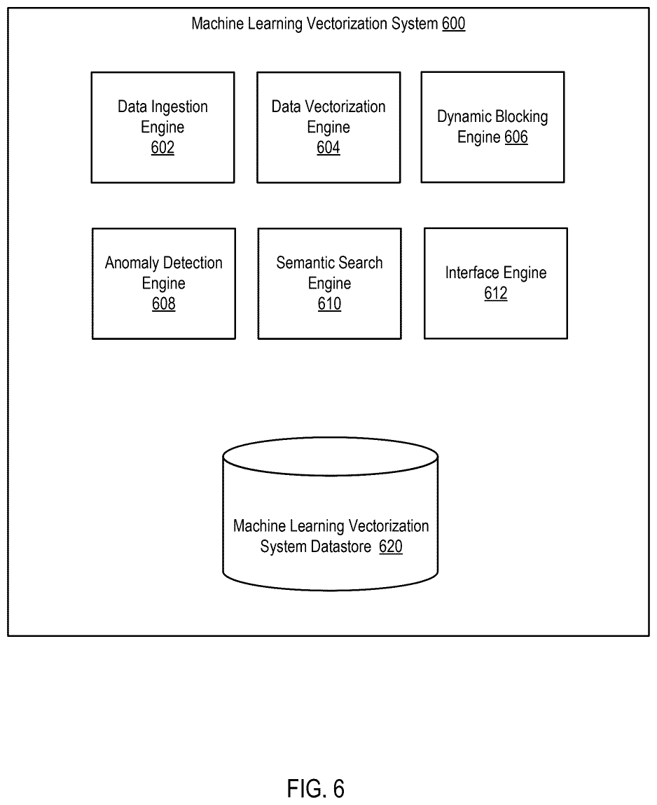

FIG. 6 depicts a diagram of an example machine learning vectorization system 600. In the example of FIG. 6, the machine learning vectorization system 600 includes a data ingestion engine 602, a data vectorization engine 604, a dynamic blocking engine 606, an anomaly detection engine 608, a semantic search engine 610, an interface engine 612, and a machine learning vectorization system datastore 620. The machine learning vectorization system 600 may be a component of the platform 102 and/or cooperate with the platform 102.

Generally, the machine learning vectorization system 600 can create and/or maintain a knowledge graph of data on an MDM platform (e.g., platform 102) that can span across one or more enterprises. Creation of vector representations of data enables capabilities that can reduce time to value (e.g., reducing time for deployment), reducing error (e.g., reducing manual error risk), and increasing ease of use (e.g., removing the need to have expert resources for matching and detecting data anomalies and reducing overall costs of deployment and management by letting vector analysis do the hard work). For example, users (e.g., administrators) do not need to decide what algorithm is best for matching two fields; rather the machine learning vectorization system 600 can use vectors to do that. As another example, user do not need to determine a blocking/token strategy; the computing system can use vectors to do that. As another example, business users need not precode business logic for data anomalies; the machine learning vectorization system 600 use vectors to do that, too.

The data ingestion engine 602 is intended to represent an engine that ingests data from a variety of different data sources having a variety of different data formats. The data ingestion engine 602 can ingest data across one or more communications networks (e.g., WAN, LAN, Internet, VPN, etc.). In some embodiments, the data ingestion engine 602 may normalize ingested data (e.g., using one or more normalization functions).

The data vectorization engine 604 is intended to represent an engine that converts ingested data into different vectors. The vectors may be arrays (e.g., single dimensional array, multidimensional array, etc.), and each of the vectors can represent an object of the ingested data. In a specific implementation, incoming data is converted to vectors that represent the data. A vector is a numeric representation of a word or string (e.g., multidimensional array). For example, “cat” and “kitten” can each be converted into multiple values (or features) that describe each object and, in this example, show a relationship through at least one feature of each that is close to the other. The machine learning vectorization system 600 can then perform mathematical computations to determine how close a cat and a kitten are to one another by comparing the representations. (e.g., a model is used to calculate scores for each vector). The machine learning vectorization system 600 can determine that cat and kitten are closer together semantically than, say, cat and dog, but cat and dog are closer together semantically than cat and house. This enables the machine learning vectorization system 600 to determine that a group of objects are similar (e.g., within a threshold distance of each other), while another object, or group of objects, is very different from the objects of the group.

Example use cases for vectors include dynamic blocking (e.g., used for candidate selection and matching), anomaly detection (determining things that are different in a data set), and semantic search (e.g., understanding the meaning of a word to establish degrees of similarity with other words). When matching, the system or user can make a rule such as “first name exact”, “last name exact”, “address similar”, and “email similar.” However, the user generally must know what “fuzzy” rules they want to use and identify a candidate pool on which to do the matching. The system may use blocking to, for example, have phonetic tokens to which anyone with a phonetic token that matches can be matched, or if an address, everybody in the same zip code. However, this method can still result in error, which the system described herein can avoid.

In some embodiments, the data vectorization engine 604 can function to compare vectors with each other. In some implementations, the data vectorization engine 604 can function to determine distances between vectors based on the comparison of the vectors. For example, the data vectorization engine 604 may use one or more machine learning models and/or algorithms (e.g., k-nearest neighbor) to determine distances.

The dynamic blocking engine 606 is intended to represent an engine that automatically determines a set of candidate matches based on determined distances between vectors. In a specific implementation, using vectors, the dynamic blocking engine 804 provides, for example, the four nearest neighbors to a candidate vector to build a block of potential candidates on which you wish to perform candidate selection dynamically without any input from the user. For example, a customer may submit “kit” to the MDM platform 102. It is no longer necessary to compare “kit” to everything, or even to everything that is of the same type of object. It takes longer to compare against a couple of things than against dozens of things. So, blocking increases compute efficiency for a given accuracy. Vectorization for the purpose of blocking enables users to avoid seeking an expert to write business rules, which can realistically take a week or two in some cases, and instead execute at the touch of a button (e.g., on-demand in real time).

The anomaly detection engine 608 is intended to represent an engine that determines an anomaly score for the input based on the determined distances between the plurality of vectors. In some embodiments, the anomaly detection engine 608 obtains an anomaly threshold value from a plurality of threshold values. For example, different fields (e.g., phone number field, name field, address field) may have different threshold values. The anomaly detection engine 608 can compare the anomaly score and the appropriate anomaly threshold value and trigger a notification if the comparison of the of anomaly score satisfies (e.g., exceed or meet) the anomaly threshold value.

The semantic search engine 610 is intended to represent an engine that uses vectorization (e.g., performed by the data vectorization engine 604) to resolve queries based on semantic matching of one or more portions of the query with the set of candidate matches. For example, once the ingested data has been vectorized by the data vectorization engine 604, the data vectorization engine 604 may use vector computations to determine how close an object (e.g., “cat”) is to one or more other objects (e.g., “kitten”, “dog”). By comparing the corresponding vectors, the data vectorization engine 604 can determine that “cat” and “kitten” are semantically similar, while the “cat” and “dog” are not semantically similar.

Advantageously, the semantic search engine 610 can use machine learning models to retrieve more relevant results for a given query, according to context and dataset. The semantic search engine 610 can also allow the merging of semantic search with existing regular text search into the same search engine, which enables users to get the best of both worlds (e.g., relevance based on the context and accuracy based on exact filters). The semantic search engine 610 can also provide the ability to query data without needing to have a deep technical knowledge (e.g., filter condition types, field names, etc.).

The interface engine 612 is intended to represent an engine that presents visual, audio, and/or haptic information. In some implementations, the interface engine 612 generates graphical user interface components (e.g., server-side graphical user interface components) that can be rendered as complete graphical user interfaces on various systems (e.g., client systems). The interface engine 612 can function to present an interactive graphical user interface for display and receiving information.

In some embodiments, the data blocking engine 606 can be characterized as a vectorized data blocking engine 606, the anomaly detection engine 608 as a vectorized anomaly detection engine 608, and the semantic search engine 610 as a vectorized semantic search engine 610. Use of a knowledge graph is supported with a unified graph for structured and unstructured data. Unstructured data is brought in to form an all-encompassing, entity-centric knowledge graph as the foundation, which can be supplemented with an activity graph. A built-in ability to mix-and-match AI models facilitates securely mixing and matching models from various providers, LLMs, and traditional models. In a specific implementation, a multimodal system of record is enhanced with an embeddable conversational interface that allows the creation and replacement of whole UIs.

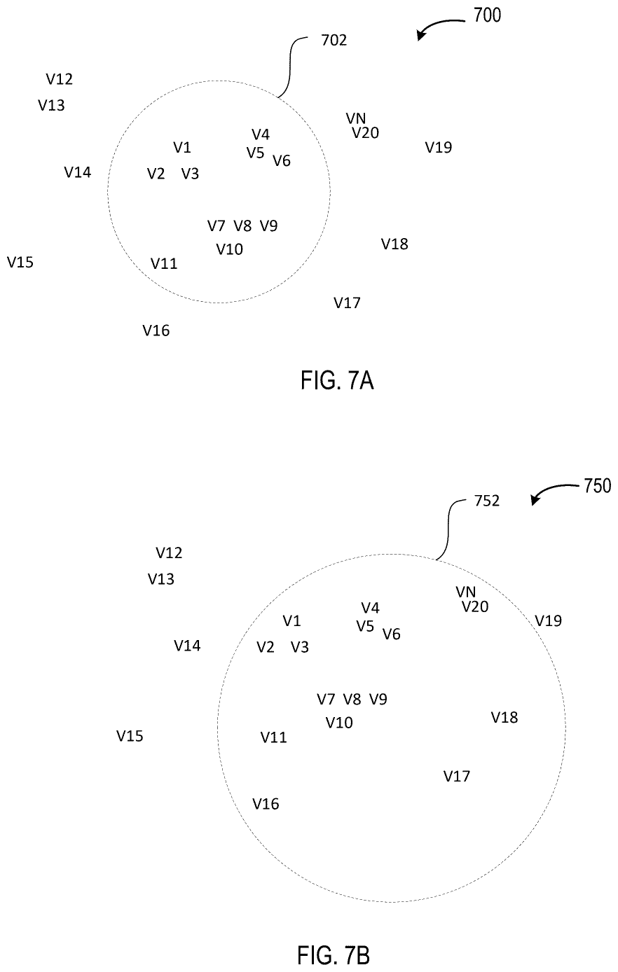

FIGS. 7A-B depicts diagrams 700 and 750 of example vector relationships with different vector relationship closeness thresholds. For illustrative purposes, in the example of FIGS. 7A-B, a vector (e.g., V1 to VN shown in FIGS. 7A-B) is a word embedding of multiple values associated with a concept. For example, “cat” might have a word embedding of values 0.6 for “living being”, 0.9 for “feline”, 0.1 for “human”, etc. The machine learning vectorization system 600 can use a function to deduce the dimensionality of the word embedding array to 2D (e.g., on a grid). The machine learning vectorization system 600 can perform similar operations to add “kitten”, “dog”, and “house” to the 2D representation. For illustrative purposes, it is assumed if a circle 702 of a first size can be drawn around multiple objects (e.g., cat and kitten), that circle 702 is representative of a first (e.g., close) relationship and if another circle 752 of a second size is drawn around multiple objects (e.g., cat, kitten, and dog), that circle 752 is representative of a second (e.g., less close) relationship. Although other functions can be used to determine “closeness,” for illustrative purposes in this paper, the drawing of circles of various sizes around an actual, conceptual, or theoretical 2D representation of objects from their respective vectors is treated as the determinant of how closely related the objects.

In some embodiments, a user can adjust a closeness threshold represented by the circles 702, 752. For example, a user can specify a threshold score (e.g., 70 out of 100) for some fields (e.g., address field), and a different threshold score (e.g., 60 out of 100) for another field (e.g., phone number field). The user may interact with a graphical slider to select a particular threshold value and the system can automatically and dynamically adjust the dynamic blocking, anomaly detection, and/or semantic search functionalities accordingly.

The size of the circle around potential candidates (e.g., V1-VN) can be different depending upon multiple factors, which can include domain knowledge derived from expert human or artificial agents, compute restraints, customer preferences, etc. In a specific implementation, circle size is globally applied because a customer generally doesn't think about blocking, but we recognize performance characteristics that require 300 comparisons is too much for common modern compute for pragmatic reasons. For example, typical blocking exercises would not need more than 300 comparisons (e.g., comparing “Joe Smith” with “all men” is just not a useful exercise in most instances). If we had faster compute, it could increase to, e.g., 400, because you need to be less pragmatic if you have more compute. Consideration of compute restraints and pragmatism are for “largeness of circle” considerations. As another example, if you know a name and social security number (SSN), you can capture everything related to it because the number of matches would be low. Specificity or deep understanding of the data being compared is for “smallness of circle” considerations.

Ideally, when blocking, you want the size of a circle to include everything that could have matched for a given execute and nothing more. In other words, it is expected circle size will be weighted in favor of false positives (including some inappropriate candidates) over false negatives (failing to include all appropriate candidates), within the constraints of compute and pragmatic considerations. Customers may or may not be given the option to tweak blocking performance to consume more compute and capture more false positives with even lower odds of false negatives or less compute to capture fewer false positives with higher odds of false negatives. Ideally, however, customers are not required to make these determinations and can rely upon the MDM platform to provide the appropriate blocking for them.

Continuing the “circle” conceptualization for the anomaly detection engine 806, when looking for things outside the circle, a customer can set sensitivity and may have different initial settings for different fields. Alternatively, the machine learning vectorization system 600 can have vectorized anomaly detection that requires no customer input. As with blocking, vectorized anomaly detection allows a customer to execute with the touch of a button, without having an expert write business rules (e.g., it is hard to write a business rule to determine what is or is not a product description). However, it may be desirable to allow a customer to choose a threshold based upon a comparison score because in some industries the need for tight comparisons might be higher than in other industries. For example, the customer could indicate they want to see anything above a given anomaly (comparison) score (e.g., difference between candidate vector score and potential anomalous candidate vector score). In a specific implementation, the anomaly threshold is presented as a slider (with examples) and allow the customer to adjust the slider as desired. The default value may be different depending upon the object (e.g., phone number may have a default threshold that is different than that of first name) and there may be different scoring structures across fields that implicate differing default threshold values.

Continuing the “circle” conceptualization for the semantic search engine 808, the semantic search engine 808 looks inside the circle to return customer objects that are within the circle (e.g., as JSON objects). Instead of using it for blocking and candidate selection, the semantic search engine 610 can use it for search. Powered by generative artificial intelligence models (e.g., large language models), the semantic search engine 610 enables users to query data using natural language. For example, if a customer searches for “banks in North Carolina”, the vectorized semantic search performed by the semantic search engine 610 may also return financial institutions and brokerages because they are semantically close to banks (and the search may order them based upon degree of similarity). The union of semantic and regular text search provides the ability to have a hybrid search capability, which potentially increases the relevance and accuracy of the results.

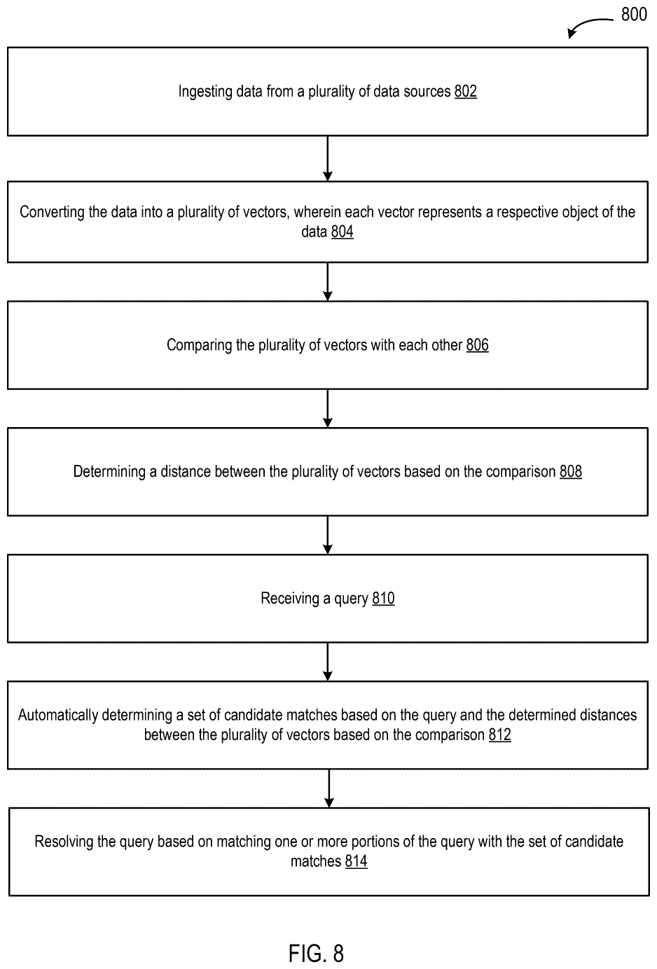

FIG. 8 depicts a flowchart 800 of an example method of vectorization for dynamic blocking. In this and other flowcharts, flow diagrams, and/or sequence diagrams, the flowchart illustrates by way of example a sequence of modules. It should be understood that the modules may be reorganized for parallel execution, or reordered, as applicable. Moreover, some modules that could have been included may have been removed to avoid providing too much information for the sake of clarity and some modules that were included could be removed but may have been included for the sake of illustrative clarity.

In step 802, a computing system (e.g., machine learning vectorization system 600) ingests data from a plurality of data sources. In some embodiments, a data ingestion engine (e.g., data ingestion engine 602) ingests the data over a communications network (e.g., WAN, LAN, Internet, VPN, etc.).

In step 804, the computing system converts the data into a plurality of vectors. Each vector can represent a respective object of the data. In some embodiments, a data vectorization engine (e.g., data vectorization engine 604) converts the data.

In step 806, the computing system compares the plurality of vectors with each other. In some embodiments, the data vectorization engine performs the comparison.

In step 808, the computing system determines a distance between the plurality of vectors based on the comparison. In some embodiments, the data vectorization engine determines the distances.

In step 810, the computing system receives a query. In some embodiments, an interface engine (e.g., interface engine 612) receives the query.

In step 812, the computing system automatically determines a set of candidate matches based on the query and the determined distances between the plurality of vectors based on the comparison. In some embodiments, a dynamic blocking engine (e.g., dynamic blocking engine 606) automatically (e.g., without requiring user input) determines the set of candidate matches.

In step 814, the computing system resolves the query based on matching one or more portions of the query with the set of candidate matches. In some embodiments, a semantic search engine (e.g., semantic search engine 610) resolves the query.

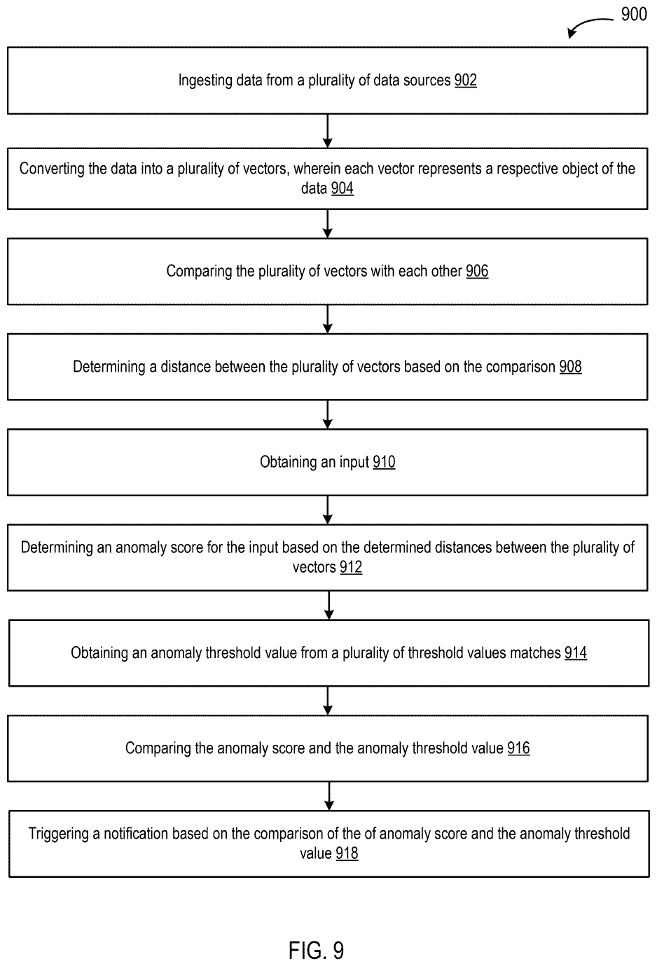

FIG. 9 depicts a flowchart 900 of an example method of vectorization for anomaly detection. In this and other flowcharts, flow diagrams, and/or sequence diagrams, the flowchart illustrates by way of example a sequence of modules. It should be understood that the modules may be reorganized for parallel execution, or reordered, as applicable. Moreover, some modules that could have been included may have been removed to avoid providing too much information for the sake of clarity and some modules that were included could be removed but may have been included for the sake of illustrative clarity.

In step 902, a computing system (e.g., machine learning vectorization system 600) ingests data from a plurality of data sources. In some embodiments, a data ingestion engine (e.g., data ingestion engine 602) ingests the data over a communications network (e.g., WAN, LAN, Internet, VPN, etc.).

In step 904, the computing system converts the data into a plurality of vectors. Each vector can represent a respective object of the data. In some embodiments, a data vectorization engine (e.g., data vectorization engine 604) converts the data.

In step 906, the computing system compares the plurality of vectors with each other. In some embodiments, the data vectorization engine performs the comparison.

In step 908, the computing system determines a distance between the plurality of vectors based on the comparison. In some embodiments, the data vectorization engine determines the distances.

In step 910, the computing system obtains an input (e.g., query). In some embodiments, an interface engine (e.g., interface engine 612) obtains the input.

In step 912, the computing system determines an anomaly score for the input based on the determined distances between the plurality of vectors. In some embodiments, an anomaly detection engine (e.g., anomaly detection engine 608) determines the anomaly score.

In step 914, the computing system obtains an anomaly threshold value from a plurality of threshold values. In some embodiments, the anomaly detection engine obtains the anomaly threshold value.

In step 916, the computing system compares the anomaly score and the anomaly threshold value. In some embodiments, the anomaly detection engine compares the anomaly score and the anomaly threshold value.

In step 918, the computing system triggers a notification based on the comparison of the of anomaly score and the anomaly threshold value. In some embodiments, the anomaly detection engine triggers the notification.

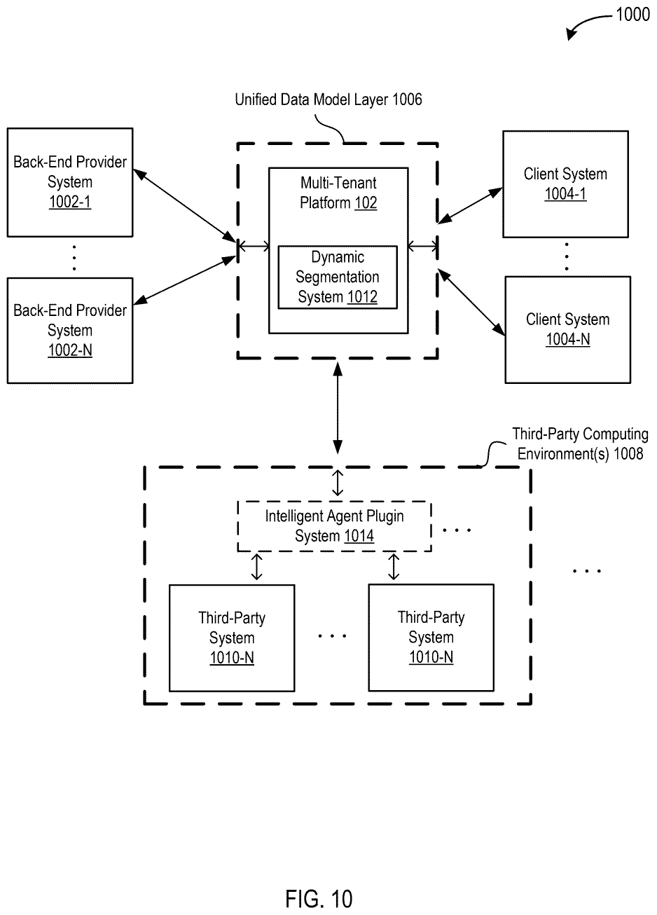

FIG. 10 depicts a diagram of an example network environment 1000 for dynamic audience segmentation and intelligent agents. In the example of FIG. 10, the network environment 1000 includes a multi-tenant platform 102 (or, simply, platform 102), back-end provider systems 1002-1 to 1002-N (individually, the back-end provider system 1002, collectively, the back-end provider systems 1002), client systems 1004-1 to 1004-N (individually, the client system 1004, collectively, the client systems 1004), a unified data model layer 1006, and third-party computing environments 1008 with third-party systems 1010-1 to 1010-N (individually, the third-party system 1010, collectively, the third-party systems 1010), a dynamic segmentation system 1012, and an intelligent agent plugin system 1014.

In the example of FIG. 10, the multi-tenant platform 102 is a multi-domain and/or multi-tenant computing platform that enables seamless integration of many types of data from many sources. The platform 102 may include a variety of different data structures having different formats, structures, data, and/or the like. The multi-tenant platform 102 may include some or all functionality and components as the platform 102 described elsewhere herein.

In some embodiments, the multi-tenant platform 102 efficiently provides secure data management without unnecessarily exposing sensitive data. More specifically, the multi-tenant platform 102 can use the unified data model layer 1006 and data management operation metadata to operate on data in the cloud environment of the platform 102 without exposing sensitive data outside the platform 102.

In the example of FIG. 10, the back-end provider systems 1002 include different back-end service provider systems. The back-end provider systems can include cloud-native service providers (e.g., AWS, Azure), hosted-service providers, and the like. The back-end service provider systems 1002 can provide storage services and/or other back-end services for the multi-tenant platform 102 and the clients (e.g., tenants) thereof.

In the example of FIG. 10, the client systems 1004 include clients of the multi-tenant platform 102. The client systems 1004 may be clients of the multi-tenant platform 102 and may be associated with one or more tenants and/or domains of the multi-tenant platform 102.

In the example FIG. 10, the unified data model layer 1006 enables the multi-tenant platform 102 to provide a logical view (e.g., single logical view) of the data structures of the multi-tenant platform 102. For example, the unified data model layer 1006 may enable the multi-tenant platform 102 to provide a respective logical view of the data structures associated with a particular tenant. In some embodiments, the unified data model layer 1006 maps different attribute fields (e.g., application fields) into a single logical view. For example, the client systems 1004 may have no idea what back-end provider 1002 that the multi-tenant platform 102 is using to store and manage their data. Accordingly, customers do not have to worry about database design and can use the unified data model across an entire enterprise.

In the example of the FIG. 10, the unified data model layer 1006 cooperates with the multi-tenant platform 102, third-party computing environments 1010, client systems 1004, back-end provider systems 1002, dynamic segmentation system 1012, and/or intelligent agent plugin system 1014 to provide single front-end across all backend service providers 1002, which can provide benefits of scaling, which can be transparently managed by the service providers 1002. For example, the multi-tenant platform 102 may “hook” into the unified data model layer to map attributes of the back-end service providers 1002 to corresponding attributes of the unified data model layer 1006. This can enable the multi-tenant platform 102 to seamlessly, dynamically, and/or transparently switch cloud-service providers 1002.

In the example of FIG. 10, the third-party computing environment 1008 comprises third-party environments remote from the multi-tenant platform 102. The third-party computing environments 1008 include third-party systems 1010 (e.g., applications and/or computers of an enterprise organization) of a network (e.g., enterprise network). The third-party computing environments 1008 may include one or more LANs, WANs, and the like (e.g., of an enterprise organization).

In the example of FIG. 10, the platform 102 includes the dynamic segmentation system 1012. It will be appreciated that in some embodiments the dynamic segmentation system 1012 may be distinct from the platform 102 and may communicate with the platform 102 (e.g., over a communications network). In one example, the dynamic segmentation system 1012 facilitates personalized campaigns and experiences, next best actions, and proactive retention strategies, and/or the like. Enterprises often struggle with finding the right audience for an interaction. With dynamic audience segmentation, the dynamic segmentation system 1012 can segment a population in a tenant (e.g., run a search with specific criteria), get a segment result set, execute a campaign and/or automatically link to and synchronize with a marketing solution (e.g., Marketo), and then interact with the population (e.g., send emails as part of a marketing campaign). Because the dynamic segmentation system 1012 can leverage data in an MDM datastore (e.g., of the dynamic segmentation system 1012 and/or platform 102), including interaction data and data associated with any applicable transaction, the search can be more specific and granular (e.g., every cardiologist in North Carolina who has issued more than one claim and written at least two prescriptions for a cardiac drug) than traditional searching methods.

In some embodiments, the dynamic segmentation system 1012 can incorporate demographic characteristics, psychographic characteristics, behavioristic characteristics, technographic characteristics, transaction characteristics, and/or the like, to create granular population segments based on profiles (e.g., profiles of members of a population) and interaction data (e.g., of those members). The data need not be sent outside the system that maintains the utilized data (e.g., platform 102 and/or dynamic segmentation system 1012). Accordingly, a third-party marketing solution (e.g., executing on third-party system 1010) could be sent a list of emails with no other data associated with it. In an alternative, the platform 102 and/or dynamic segmentation system 1012 can provide anonymized emails to the third-part marketing solution and forward the anonymized emails from the third-party marketing solution to the audience segment, and then either reuse or recycle the anonymized email. Advantageously, the dynamic segmentation system 1012 can activate dynamic audience segmentation in real time and/or batches, and can also store queries to rerun at any time without persisting the output. In a specific implementation, the dynamic segmentation system 1012 can recommend and/or predict segments with predictive intelligence. In a specific implementation, data is masked so a user cannot see it but can still build segments.

In a specific implementation, a rule builder of the dynamic segmentation system 1012 can find customer records based on entities and interactions at the same time so that a marketing team can use this “segment” or “segment audience” for execution of campaigns in marketing activation platform. The members of each segment can be updated in real time based on different activities (e.g., interactions) making them truly dynamic in nature. Notably, dynamic audience segmentation and activation enables personalized group interaction (e.g., targeted marketing campaigns tailored to a segment), improved customer experience and retention (e.g., by delivering more relevant and engaging customer experiences), and increased conversion rate (e.g., via enhanced effectiveness of marketing efforts).

In the example of FIG. 10, the intelligent agent plugin system 1014 facilitates harnessing proprietary data while utilizing large language models (LLMs) and/or other generative artificial intelligence models. For example, a customer (e.g., tenant of the platform 102) can potentially use the intelligent agent plugin system 1014 from an edge device (e.g., third-party system 1010) to query the platform 102 without learning the platform 102 interface. In some embodiments, the intelligent agent plugin system 1014 includes a conversational interface to a large language model (and can run a request for it) and/or other generative artificial intelligence models. In some embodiments, the intelligent agent plugin system 1014 can hook into the unified data model layer 1006 for an added layer of security.

In a specific implementation, the intelligent agent plugin system 1014 is platform agnostic and integrates with third party applications and/or systems (e.g., third-party system 1010). The plugin 1014 allows users to access an intelligent assistant and data directly from the third-party applications 1010, while ensuring security compliance. The intelligent agent plugin system 1014 can be used for generative insights off-platform. For example, a user (e.g., enterprise executive) may want to know how many customers are in the top 5% of customers and bought something in the last two days and have quarterly filing in two months. The user can obtain an answer through the intelligent agent plugin system 1014. The user does not need to need to directly access the platform 102 or ask an employee to create a report or chart; the data is available through the intelligent agent plugin system 1014 by simply asking the question.

Advantageously, users can access their most reliable data (e.g., stored by the platform 102) on their primary application (e.g., executing on a third-party system 1010). The intelligent agent plugin system 1014 can also reduce the total actions and/or stakeholders required for enterprise users to get actionable data insights and reduce the overall turnaround time. The intelligent agent plugin system 1014 can also improve the reach and enterprise accessibility of unified and mastered data and increase the productivity of enterprise users and data stewards through its simplified interface and access.

In a specific implementation, the dynamic segmentation system 1012 can intelligently segment a population (e.g., comprising members) of a tenant of the platform 102. For example, a user (e.g., a customer associated with a particular tenant) can use the dynamic segmentation system 1012 (or the intelligent agent plugin system 1014 interacting with the dynamic segmentation system 1012) to execute a search (or, segment query) with a specific criteria on the population and obtain a segment result set from that search and the dynamic segmentation system 1012 can automatically synchronize that segment result set with different third-party applications and/or system 1010, and trigger those third-party applications and/or systems 1010 (e.g., third-party marketing solutions, third-party software deployment solutions, etc.) to perform various campaign actions, such as sending an email campaign to the members of the segment result set, and/or deploying software updates of a software deployment campaign to the members of the segment result set.

Accordingly, for example, a user can execute granular searches and then press a button and everyone in the segment result set can get an email campaign built with a third-party system 1010. Notably, the search can include much more information resulting in a much broader and more accurate search. For example, by including dynamic data (e.g., interaction data) the dynamic segmentation system 1012 can do more than merely find every healthcare provider in North Carolina who is a cardiologist—the dynamic segmentation system 1012 can find every healthcare provider in North Carolina who is a cardiologist and that has issued more than one claim in the last month and also written at least 2 prescriptions for a cardiac drug, and that has responded to at least one previous campaign, and then email those specific members, and the results of the search can become dynamic based on data the dynamic segmentation system 1012 is collecting and applying.

In some embodiments, the dynamic segmentation system 1012 can query static attributes about the population and their actual transactional information (e.g., dynamic attributes) at the same time. Some traditional systems can fire off emails but cannot find the correct segment of a population to send emails to. The dynamic segmentation system 1012 can identify the correct population segment and generate and transmit an API call to another application (e.g., third-party system 1010) to execute various campaign actions. Accordingly, the dynamic segmentation system 1012, unlike those other systems, does not have to send data outside the dynamic segmentation system 1012 and/or platform 102. Rather, the dynamic segmentation system 1012 can, for example, just send out a list of 45 members and the third-party systems 1010 can fire off the emails while the dynamic segmentation system 1012 and/or platform 102 maintains the underlying data without exposing it externally. Users typically already have this data on the platform 102, and building the integration to send all of this data outside of the platform 102 not only has privacy issues, but also technical problems (e.g., latency issues). The dynamic segmentation system 1012 can avoid the technical overhead since the data is already on the platform 102 and/or dynamic segmentation system 1012, and the dynamic segmentation system 1012 can provide a granular query capability so that a user can build relatively small population segments and instruct third-party systems 1010 to perform various campaign actions (e.g., sending emails, software deployment updates, etc.).

In some embodiments, the dynamic segmentation system 1012 can mask data. For example, the dynamic segmentation system 1012 can execute a segment query and can still find that data and return it but the user would not be able to view it because it is masked in the return field. Accordingly, a user could use the dynamic segmentation system 1012 to build segments even if it did not return the absolute value in that field being used in the query. For example, a query may be, “Give me every cardiologist that is in North Carolina.” The user does not necessarily need to know every detail about the members of the returned segment result set, so the dynamic segmentation system 1012 may just show the user a masked result set which can then be sent to a third-party system 1010.

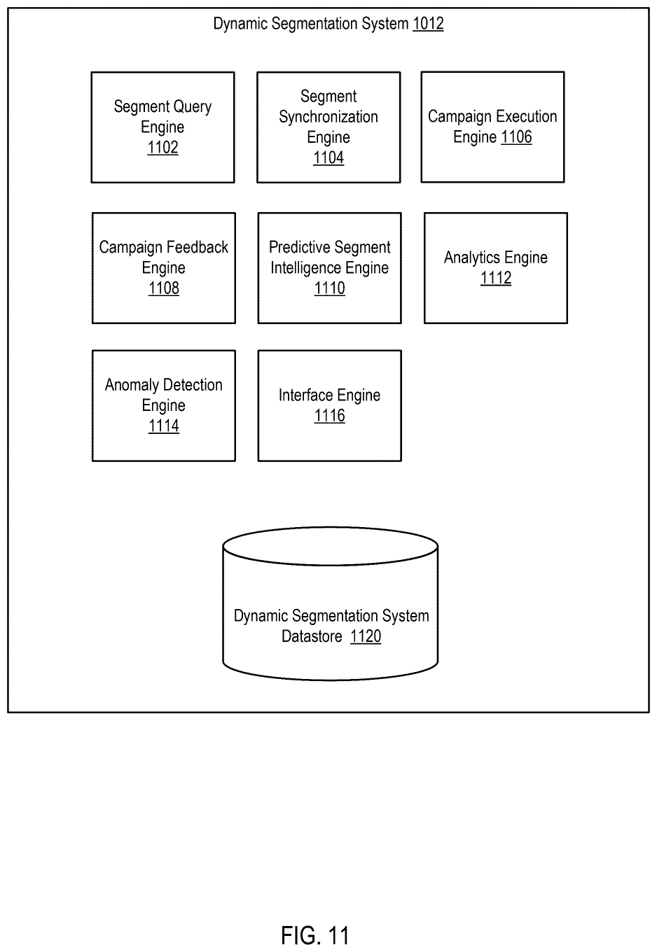

FIG. 11 depicts a diagram of an example dynamic segmentation system 1012 that facilitates personalized campaigns and experiences, next-best actions, and proactive retention strategies, to name a few examples. In the example of FIG. 11, the dynamic segmentation system 1012 includes a segment query engine 1102, a segment synchronization engine 1104, a campaign execution engine 1106, a campaign feedback engine 1108, a predictive segment intelligence engine 1110, an analytics engine 1112, an anomaly detection engine 1112, an interface engine 1116, and a dynamic segmentation system datastore 1120.

The segment query engine 1102 is intended to represent an engine that can receive, generate (e.g., create, read, update, delete), transmit, execute (e.g., periodically and/or on-demand), and/or store (e.g., for re-execution) segment queries. The segment queries may include static attributes and dynamic attributes. For example, static attributes can include identification information (e.g., name, address, phone number, company, demographic information, psychographic information, etc.), and the dynamic attributes may include transaction information, such as interaction data. Interaction data can include how an entity (e.g., tenant) interacts with the platform 102 and/or other systems, such as whether a user interacted with a campaign action (e.g., opened an email triggered by the dynamic segmentation system 1012, whether a user applied a software update triggered by the dynamic segmentation system 1012, and/or the like).

In some embodiments, the dynamic attributes include machine learning model recommendations and/or predictions (or other machine learning model outputs). For example, the dynamic attributes can include predictions of a likelihood that one or more entities of a population of a tenant of the multi-tenant platform 102 will take one or more actions (e.g., respond to an email, accept a software deployment update, etc.). The interaction data can include loopbacks (e.g., data can be updated with a second transaction when an email that is part of an interaction is opened). This is useful for, for example, incorporating data such as propensity to churn, propensity to buy, and propensity to respond to a marketing campaign, to name a few. Accordingly, the segment query engine 1102 can obtain (e.g., receive) updated data for the static attributes and dynamic attributes.

In some embodiments, the segment query engine 1102 can function to generate segment result sets by executing one or more segment queries. The segment result set may include a segment of a population of a tenant of the multi-tenant platform. In some embodiments, the segment query engine 1102 can also function to execute, either periodically or on-demand, stored segment queries (e.g., previously created segment queries) using the updated data for the static attributes and the dynamic attributes. In some embodiments, the segment query engine re-executes the stored segment query either periodically or on demand.

The segment synchronization engine 1104 is intended to represent an engine that automatically (e.g., without requiring user input) synchronizes the segment result set with one or more third-party systems (e.g., third-party systems 1010). For example, the segment synchronization engine 1104 can automatically synchronize the segment result set with one or more third-party systems in response generating the segment result set and/or executing the segment query.

The campaign execution engine 1106 is intended to represent an engine that triggers (e.g., in response to the automatic synchronization) the one or more third-party systems to perform one or more campaign actions (e.g., a deployment of a software update) of a campaign (e.g., software deployment campaign) using the segment included in the segment result set.

The campaign feedback engine 1108 is intended to represent an engine that collects data about a campaign itself, which can be used for further segmentation. The campaign feedback engine 1108 can perform updates on members of population segments, transactions, responses to interactions, and/or the like. For example, as discussed above, the interactions can include loopbacks (e.g., data can be updated with a second transaction when an email that is part of an interaction is opened). This is useful for, for example, incorporating data such as propensity to churn, propensity to buy, and propensity to respond to a marketing campaign, to name a few.

In one example, the dynamic segmentation system 1012 may store profiles for members of a population. For example, there may be a profile for Dr. Smith that includes transaction data indicating that dynamic segmentation system 1012 triggered an email sent to him and another transaction indicating that he opened the email and the time and browser used, whether it was on a mobile device of PC, the IP address that he opened the email from, the geolocation based on IP address, and/or the like, and then store that on the transaction itself within the profile, which can then be used for the same campaign or other campaign (e.g., a subsequent campaign).

For example, the next campaign can exclude everyone who has not opened an email in the last six campaigns based on the updated interaction data and updated member profiles. This can result in extremely robust member profiles which can be used to predict the responsiveness of individuals (e.g., by the predictive segment intelligence engine 1110), such as propensity to churn and propensity to buy analytics based on these transactions and propensity to respond to a marketing campaign with a scoring model associated with that. Many propensity models across different industries may be used by the predictive segment intelligence engine 1110, such as industry-specific models, individual-specific models, customer-provided models, and/or the like.

The predictive segment intelligence engine 1110 is intended to represent an engine that can use machine learning models to predict and/or recommend a response likelihood of one or more entities (or, members) of a population of a tenant of the multi-tenant platform 102. Machine learning models can include, for example, neural network models, transformer-based models, generative artificial intelligence models, large language models, omnimodal models, convolutional neural network (CNN) models, graph neural network (GNN) models, deep learning models, supervised learning models, unsupervised learning models, random forest models, Bayesian models, and/or the like. In some embodiments, the predictive segment intelligence engine 1110 can function to obtain and/or generate different machine learning models.

The predictive segment intelligence engine 1110 can function to generate inputs for one or machine learning models. The predictive segment intelligence engine 1110 may generate the machine learning input data based on (e.g., using) some or all of the data and attributes described herein. For example, the predictive segment intelligence engine 1110 may generate machine learning input data based on user inputs, system inputs/outputs, segment queries, dynamic attributes, static attributes, and/or the like. More specifically, the predictive segment intelligence engine 1110 can identify features from the data and generate feature vectors from that data and the feature vectors can be the inputs for the machine learning models.

In some embodiments, the predictive segment intelligence engine 1110 may normalize data to a standard format (e.g., normalized data format). The standard format may be the data format used by the machine learning models. This can allow the dynamic segmentation system 1012 to obtain data from many different data sources regardless of the original format, allowing the dynamic segmentation system 1012 to operate on the data regardless of any original format.

The analytics engine 1112 is intended to represent an engine that obtains, generates, executes, and/or transmits analytics. For example, the analytics engine 1112 can execute analytics on segment results sets to determine demographic information, behavioral information, psychographic information, technographic information, and/or transactional information for population segments (e.g., segment result sets).

The anomaly detection engine 1112 is intended to represent an engine that can detect anomalies (e.g., fraud). More specifically, the anomaly detection engine 1112 can determine a segment anomaly score based on differences between segments and/or members of a segment of a segment result set. In some embodiments, the anomaly detection engine 608 obtains an anomaly threshold value from a plurality of threshold values. For example, different fields of member profiles (e.g., phone number field, name field, address field) may have different threshold values. The anomaly detection engine 1112 can compare the anomaly score and the appropriate anomaly threshold value and trigger a notification if the comparison of the anomaly score satisfies (e.g., exceeds or meets) the anomaly threshold value.

The interface engine 1116 is intended to represent an engine that presents visual, audio, and/or haptic information. In some implementations, the interface engine 1116 generates graphical user interface components (e.g., server-side graphical user interface components) that can be rendered as complete graphical user interfaces on various systems (e.g., client systems). The interface engine 1116 can function to present an interactive graphical user interface for displaying and receiving and transmitting information.

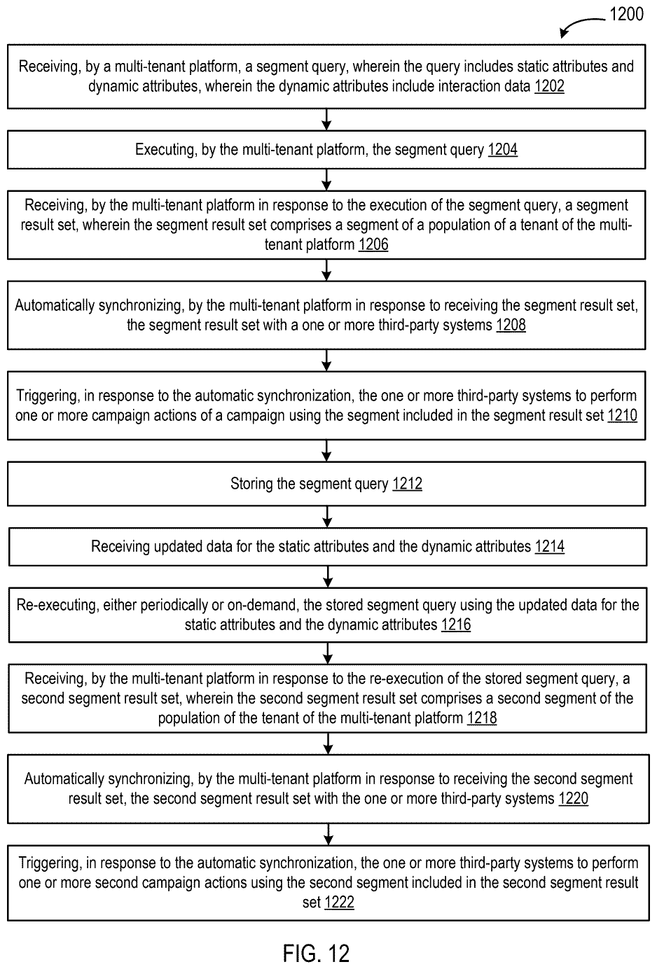

FIG. 12 depicts a flowchart 1200 of an example method of dynamic segmentation. In this and other flowcharts, flow diagrams, and/or sequence diagrams, the flowchart illustrates by way of example a sequence of modules. It should be understood that the modules may be reorganized for parallel execution, or reordered, as applicable. Moreover, some modules that could have been included may have been removed to avoid providing too much information for the sake of clarity and some modules that were included could be removed but may have been included for the sake of illustrative clarity.

In module 1202, a computing system (e.g., multi-tenant platform 102 and/or dynamic segmentation system 1012) receives, by a multi-tenant platform, a segment query. The segment query may include static attributes and dynamic attributes. The dynamic attributes may include interaction data. In some embodiments, a segment query engine (segment query engine 1102) receives the segment query.

In module 1204, the computing system executes, by the multi-tenant platform, the segment query. In some embodiments, the segment query engine executes the segment query.

In module 1206, the computing system receives, by the multi-tenant platform in response to the execution of the segment query, a segment result set. The segment result set may include a segment of a population of a tenant of the multi-tenant platform. In some embodiments, the segment query engine and/or segment synchronization engine (e.g., segment synchronization engine 1104) receives the segment result set.

In module 1208, the computing system automatically synchronizes, by the multi-tenant platform in response to receiving the segment result set, the segment result set with one or more third-party systems (e.g., third-party systems 1010). In some embodiments, the segment synchronization engine performs the automatic synchronization.

In module 1210, the computing system triggers, in response to the automatic synchronization, the one or more third-party systems to perform one or more campaign actions (e.g., a deployment of a software update) of a campaign (e.g., software deployment campaign) using the segment included in the segment result set. In some embodiments, a campaign execution engine (e.g., campaign execution engine 1106) triggers the one or more third-party systems to perform the one or more campaign actions of the campaign.

In module 1212, the computing system stores the segment query. In some embodiments, the segment query engine stores the segment query.

In module 1214, the computing system receives updated data for the static attributes and the dynamic attributes. In some embodiments, the segment query engine and/or segment synchronization engine receives the updated data.

In module 1216, the computing system re-executes, either periodically or on-demand, the stored segment query using the updated data for the static attributes and the dynamic attributes. In some embodiments, the segment query engine re-executes the stored segment query.

In module 1218, the computing system receives, by the multi-tenant platform in response to the re-execution of the stored segment query, a second segment result set. The second segment result set may include a second segment of the population of the tenant of the multi-tenant platform. In some embodiments, the segment synchronization engine and/or segment query engine receive the second segment result set.

In module 1220, the computing system automatically synchronizes by the multi-tenant platform in response to receiving the second segment result set, the second segment result set with the one or more third-party systems. In some embodiments, the segment synchronization engine performs the automatic synchronization.

In module 1222, the computing system triggers, in response to the automatic synchronization, the one or more third-party systems to perform one or more second campaign actions using the second segment included in the second segment result set. In some embodiments, the campaign execution engine triggers the performance of the one or more second campaign actions

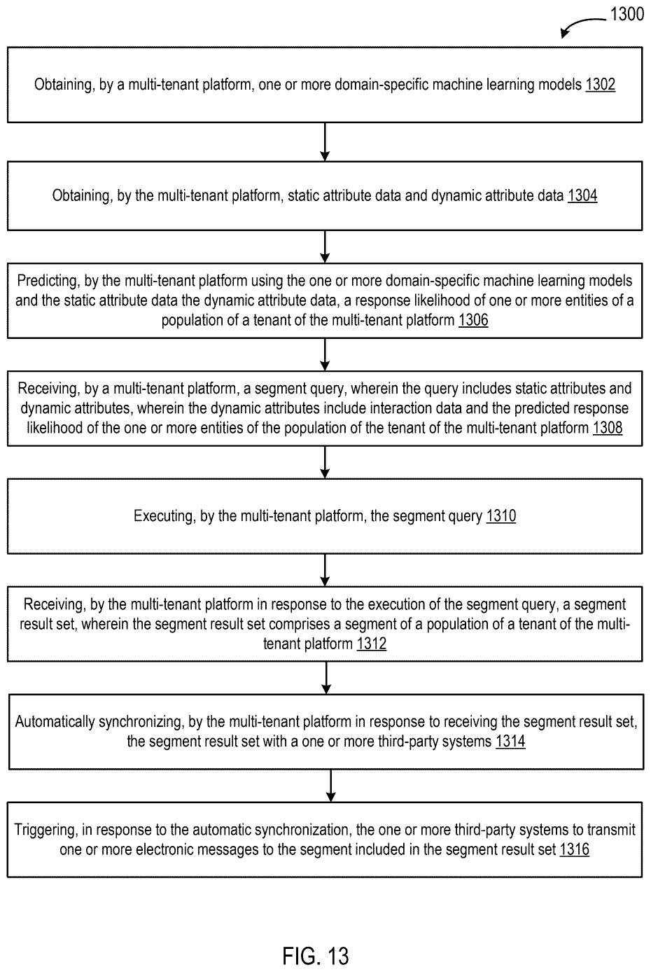

FIG. 13 depicts a flowchart 1300 of an example method of machine learning-based dynamic segmentation. In this and other flowcharts, flow diagrams, and/or sequence diagrams, the flowchart illustrates by way of example a sequence of modules. It should be understood that the modules may be reorganized for parallel execution, or reordered, as applicable. Moreover, some modules that could have been included may have been removed to avoid providing too much information for the sake of clarity and some modules that were included could be removed but may have been included for the sake of illustrative clarity.

In module 1302, a computing system (e.g., multi-tenant platform 102 and/or dynamic segmentation system 1012) obtains, by a multi-tenant platform, one or more domain-specific machine learning models. In some embodiments, a predictive segment intelligence engine (e.g., predictive segment intelligence engine 1110) obtains one or more domain-specific machine learning models.

In module 1304, the computing system obtains, by the multi-tenant platform, static attribute data and dynamic attribute data. In some embodiments, the predictive segment intelligence engine obtains the data.

In module 1306, the computing system predicts, by the multi-tenant platform using the one or more domain-specific machine learning models and the static attribute data and the dynamic attribute data, a response likelihood of one or more entities of a population of a tenant of the multi-tenant platform. In some embodiments, the predictive segment intelligence engine performs the prediction.

In module 1308, the computing system receives (and/or generates), by a multi-tenant platform, a segment query. The segment query may include static attributes and dynamic attributes, and the dynamic attributes may include interaction data and the predicted response likelihood of the one or more entities of the population of the tenant of the multi-tenant platform. In some embodiments, a segment query engine (e.g., segment query engine 1102) receives (and/or generates) the segment query.

In module 1310, the computing system executes, by the multi-tenant platform, the segment query. In some embodiments, the segment query engine executes the segment query.

In module 1312, the computing system receives, by the multi-tenant platform in response to the execution of the segment query, a segment result set. The segment result set may include a segment of a population of a tenant of the multi-tenant platform. In some embodiments, the segment query engine and/or segment synchronization engine (e.g., segment synchronization engine 1104) receives the response.

In module 1314, the computing system automatically synchronizes, by the multi-tenant platform in response to receiving the segment result set, the segment result set with one or more third-party systems (e.g., third-party systems 1010). In some embodiments, the segment synchronization engine 1104 performs the automatic synchronization.

In module 1316, the computing system triggers, in response to the automatic synchronization, the one or more third-party systems to transmit one or more electronic messages (e.g., emails) to the segment included in the segment result set. The computing system may also trigger one or more other campaign actions instead of, or in addition to, transmitting the electronic messages. In some embodiments, a campaign execution engine (e.g., campaign execution engine 1106) triggers the one or more third-party systems to transmit the one or more electronic messages to the segment included in the segment result set.

It will be appreciated that in the example of flowchart 1300, the dynamic segmentation system 1012 is part of the platform 102. Accordingly, each of the modules of flowchart 1300 may be described as being performed by the dynamic segmentation system 1012.

In other embodiments, the dynamic segmentation system 1012 is distinct from the platform 102. In such embodiments, each of the steps performed by the multi-tenant platform may be more accurately described as being performed by the dynamic segmentation system 1012.

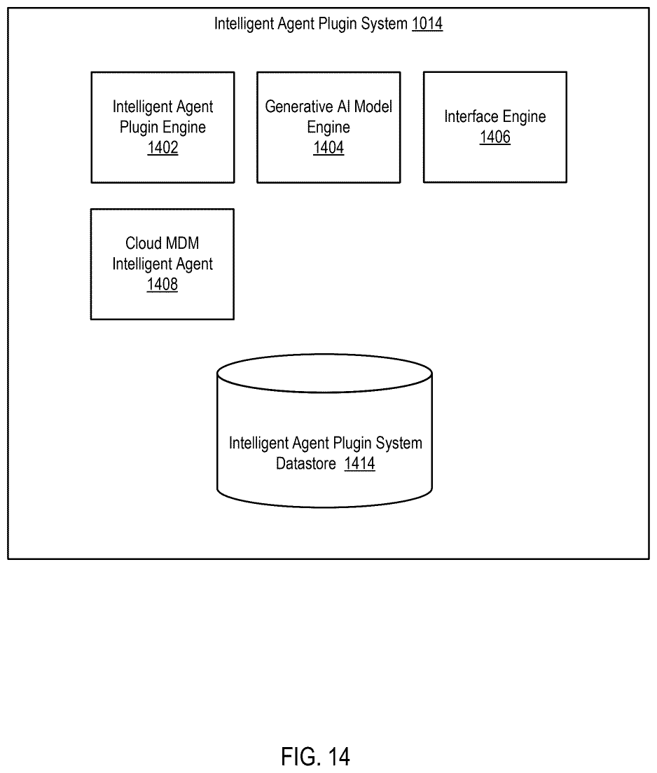

FIG. 14 depicts a diagram of an example intelligent agent plugin system 1014. In the example of FIG. 14, the intelligent agent plugin system 1014 includes an intelligent agent plugin engine 1402, a generative artificial model engine 1404, an interface engine 1406, a cloud MDM intelligent agent 1408, and an intelligent agent plugin system datastore 1414.

The generative artificial intelligence summarization engine 1402 is intended to represent an engine that can use one or more large language models (e.g., of the generative artificial model engine 1404) to generate concise, human-readable profile summaries based on entity attributes in a datastore (e.g., datastore 1414 and/or datastore of the platform 102), such as cloud MDM datastore. Through the interface engine 1406, users can query profiles and obtain summarized key information such as name, location, and contact details, providing a direct profile link for further exploration.

Notably, the intelligent agent plugin system 1014 can be distinct from the dynamic segmentation system 1012 and/or platform 102 and can be deployed inside an enterprise environment (e.g., of a customer/user). Accordingly, the customer can utilize the features of the dynamic segmentation system 1012 and/or platform 102 via the intelligent agent plugin system 1014 without having direct to directly access to the dynamic segmentation system 1012 and/or platform 102. Accordingly, data can be safeguarded within the platform 102 and/or dynamic segmentation system 1012, without exposing the data to any external environments (e.g., third-party environments 1008).

The generative artificial model engine 1404 is intended to represent an engine that can generate, update, deploy, and/or execute various generative artificial intelligence models (e.g., large language models).

In some embodiments, the intelligent agent plugin system 1014 enables users to view potential matches for specific entities, such as individuals or organizations, using natural language queries. The enhanced user experience allows users to take necessary action directly within the interface and summarize profile data and summarize match information in tenant for new skills. This can empower users with intuitive, natural language search capabilities; enhances productivity by offering a faster, more user-friendly alternative to traditional search methods; simplifies match resolution by integrating “Merge” or “Not a Match” actions directly into the intelligent assistant; and facilitates quicker decision-making on potential matches.

In some embodiments, the intelligent agent plugin engine 1002 facilitates harnessing proprietary data while utilizing LLM. A customer can potentially use the plugin from an edge device 1004 to query a cloud MDM intelligent agent 1006 of the MDM platform without learning the MDM platform interface. The intelligent agent includes a conversational interface to an LLM 1008 (and can run a request for it).

In a specific implementation, a platform agnostic UI plugin integrates with third party applications. This plugin allows users to access an intelligent assistant and data directly from the third-party application, while ensuring security compliance. The plugin is used for generative insights off-platform. For example, if you are an executive and want to know how many customers in my top 5% bought something in last two days and have quarterly filing in two months, you can obtain the answer through the plugin. You don't need to ask an employee to create a report or chart; the data is available through the plugin by simply asking the question.

Advantageously, users of our customer organizations can access their most reliable data on their primary application; the plugin reduces the total actions/stakeholders required for business users to get actionable data insights and reduces the overall turnaround time; the plugin improves the reach and enterprise accessibility of unified and mastered data; and the plugin increases the productivity of enterprise users and data stewards through its simplified interface and access.

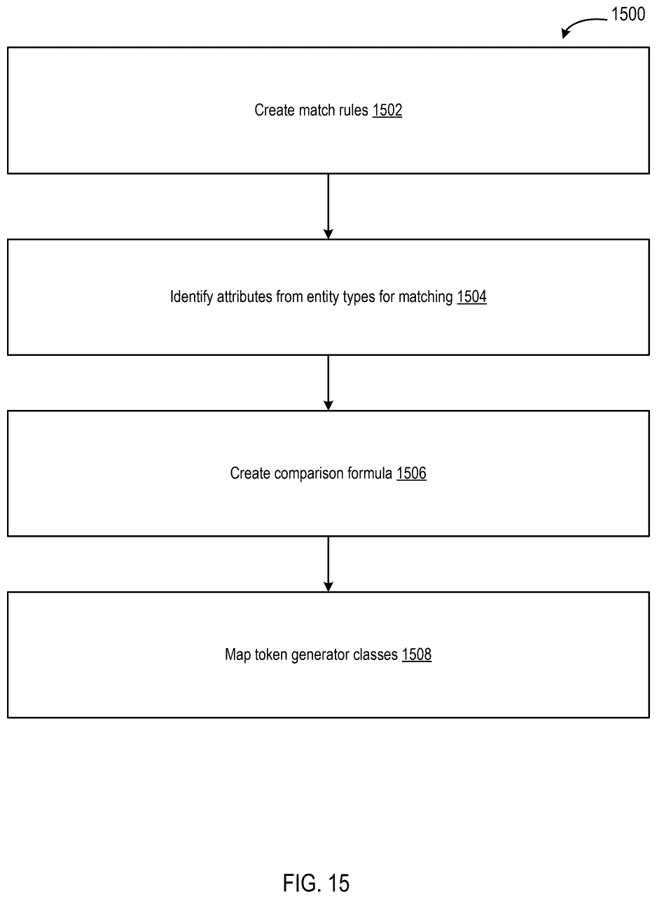

FIG. 15 depicts a dynamic matching facilitation flowchart. In this and other flowcharts, flow diagrams, and/or sequence diagrams, the flowchart illustrates by way of example a sequence of modules. It should be understood that the modules may be reorganized for parallel execution, or reordered, as applicable. Moreover, some modules that could have been included may have been removed to avoid providing too much information for the sake of clarity and some modules that were included could be removed but may have been included for the sake of illustrative clarity.

The match architecture is responsible for identifying profiles within the tenant that are considered to be semantically the same or similar. A user may establish a match scheme using the match configuration framework. In some embodiments, the user may utilize machine learning techniques to match profiles. In step 1502, the user may create match rules. In step 1504, the user may identify the attributes from entity types they wish to use for matching. In step 1506, the user may write a comparison formula within each match rule which is responsible for doing the actual work of comparing one profile to another. In step 1508, the user may map token generator classes that will be responsible for creating match candidates.

Unlike other systems, in various embodiments, the architecture is designed to operate in real time. Prior to the match process and merge processes occurring, every profile created or updated is may be cleansed on-the-fly by the profile-level cleansers. Thus the 3-step sequence of cleanse, match, merge may be designed to all occur in real time anytime a profile is created or updated. This behavior makes the platform 102 ideal for real-time operational use within a customer's ecosystem.

Lastly, the survivorship architecture is responsible for creating the classic “golden record”, but in a specific implementation, it is a view, materialized on-the-fly. It is returned to any API call fetching the profile and contains a set of “Operational Values” from the profile, which are selected in real time based on survivorship rules defined for the entity type.

In various embodiments, matching may operate continuously and in real time. For example, when a user creates or updates a record in the tenant, the platform cleanses and processes the record to find matches within the existing set of records.

Each entity type (e.g., contact, organization, product) may have its own set of match groups. In some embodiments, each match group holds a single rule along with other properties that dictate the behavior of the rule within that group. Comparison Operators (e.g., Exact, ExactOrNull, and Fuzzy) and attributes may comprise a single rule.

Match tokens may be utilized to help the match engine quickly find candidate match values. A comparison formula within a match rule may be used to adjudicate a candidate match pair and will evaluate to true or false (or a score if matching is based on relevance).

In some embodiments, the matching function may do one of three things with a pair of records: Nothing (if the comparison formula determines that there is no match); Issue a directive to merge the pair; Issue a directive to queue the pair for review by a data steward. In some embodiments, the architecture may include the following:
1) Entities and relationships each have configurable attribution capability.
2) Values found in an attribute are associated with a crosswalk held within an entity or relationship object. Each profile can have multiple crosswalks, each contributing one or more values. Data may come from multiple sources. Each source may be registered, and all data loaded into a tenant will be associated with a data source. Each supplied attribute may be associated with data provider crosswalks. Crosswalks are analogous to the Primary Key or Unique Identifier in relational database management system (RDBMS). A crosswalk can represent a data provider or a non-data provider.
3) Data providers supply attribute values for an object and the attributes are associated with the crosswalk.
4) Non-data providers are associated with an overall entity (or relationship). In this case it is simply used to link a Reltio object with an object in another system. Supplied attributes may NOT be associated with this crosswalk.
5) Profiles can be matched and merged, but relationships are also matched and merged. While the user may develop match rules to govern the matching and merging of profiles, merging of relationships is automatic and intrinsic to the platform. Any two relationships of the same type, that each have entity A at one endpoint and entity B at their other endpoint, will merge automatically.
6) An attribute is intrinsically multi-valued, meaning it can hold multiple values. This means any attribute can collect and store multiple values from contributing sources or through merging of additional crosswalks. Thus, if a match rule utilizes the first name attribute, then the match engine will by default, compare all values held within the first name attribute of record A to all values held within the first name attribute of record B, looking for matches among the values. The user may elect to only match on operational values if desired.
7) When two profiles merge, the resulting profile contains the aggregate of all the crosswalks of the two contributing profiles and thus the associated attributes and values from those crosswalks. The arrays behind the attributes naturally merge as well, producing for each attribute an array that holds the aggregation of all the values from the contributing attributes. Relationships benefit from the same architecture and behave in the same manner as described for merged entities. The surviving entity ID (or relationship ID) for the merged profile (or relationship) is that of the oldest of the two contributors. Other than that, there really isn't a concept of a winner object and a loser object.
8) When two profiles merge the resulting profile contains references to all the interactions that were previously associated with the contributing profiles. (Note that Interactions do not reference relationships.)
9) If profile B is unmerged from the previous merge of A and B, then B will be reinstated with its original entity ID. All of the attributes (and associated values), relationships, and interactions profile B brought into the merged profile will be removed from the merged profile and returned to profile B.

The matchGroups construct is a collection of match groups with rules and operators that are needed for proper matching. If the user needs to enable matching for a specific entity type in a tenant, then the user may include the matchGroups section within the definition of the entity type in the metadata configuration of the tenant. The matchGroups section will contain one or more match groups, each containing a single rule and other elements that support the rule.

Looking at a match group in a JSON editor, the user can easily see the high-level, classic elements within it. The rule may define a Boolean formula (see the AND operator that anchors the Boolean formula in this example) for evaluating the similarity of a pair of profiles given to the match group for evaluation. It is also within the rule element that four other very common elements may be held: ignoreInToken (optional), Cleanse (optional), matchTokenClasses (required), and comparatorClasses (required). The remaining elements that are visible (URI, label, and so on), and some not shown in the snapshot, surround the rule and provide additional declarations that affect the behavior of the group and in essence, the rule.

Each match group may be designated to be one of four types: automatic, suspect, <custom>, and relevance_based described below. The type the user selects may govern whether the user develops a Boolean expression for the comparison rule or an arithmetic expression. The types are described below.

Behavior of the automatic type: With this setting for type, the comparison formula is purely Boolean and if it evaluates to TRUE, the match group will issue a directive of merge which, unless overridden through precedence, will cause the candidate pair to merge.

Behavior of the suspect type: With this setting for type, the comparison formula is purely Boolean and if it evaluates to TRUE, the match group will issue a directive of queue for review which, unless overridden through precedence, will cause the candidate pair to appear in the “Potential Matches View” of the MDM UI.

Behavior of the relevance_based type: Unlike the preceding rules, all of which are based on a Boolean construction of the rule formula, the relevance-based type expects the user to define an arithmetic scoring algorithm. The range of the match score determines whether to merge records automatically or create potential matches.

If a negativeRule exists in the matchGroups and it evaluates to true, any merge directives from the other rules are demoted to queue for review. Thus, in that circumstance, no automatic merges will occur. The Scope parameter of a match group defines whether the rule should be used for Internal Matching or External Matching or both. External matching occurs in a non-invasive manner and the results of the match job are written to an output file for the user to review. Values for Scope are: ALL-Match group is enabled for internal and external matching (Default setting). NONE-Matching is disabled for the match group. INTERNAL-Match group is enabled for matching records within the tenant only. EXTERNAL-Match group is enabled only for matching of records from an external file to records within the tenant; in a specific implementation, external matching is supported programmatically via an External Match API and available through an External Match Application found within a console, such as a RELTIO™ Console.

If set to true, then only the OV of each attribute will be used for tokenization and for comparisons. For example, if the First Name attribute contains “Bill”, “William”, “Billy”, but “William” is the OV, then only “William” will be considered by the cleanse, token, and comparator classes.

The rule is the primary component within the match group. It contains the following key elements each described in detail: IgnoreIn Token, Cleanse, matchTokenClasses, comparatorClasses, Comparison formula.

A negative rule allows a user to prevent any other rule from merging records. A match group can have a rule or a negative rule. The negative rule has the same architecture as a rule but has the special behavior that if it evaluates to true, it will demote any directive of merge coming from another match group to queue for review. To be sure, most match groups across most customers' configurations use a rule for most matching goals. But in some situations, it can be advantageous to additionally dedicate one or more match groups to supporting a negative rule for the purpose of stopping a merge based on usually a single condition. And when the condition is met, the negative rule prevents any other rule from merging the records. So in practice, the user might have seven match groups each of which use a rule, while the eighth group uses a negative rule.

The platform 102 may include a mechanism to proactively monitor match rules in tenants across all environments. In some embodiments, after data is loaded into the tenant, the proactive monitoring system inspects every rule in the tenant over a period of time and the findings are recorded. Based on the percentage of entities failing the inspections, the proactive monitoring system detects and bypasses match rules that might cause performance issues and the client may be will be notified. The bypassed match rules will not participate in the matching process.

In various embodiments, the user receives a notification when the proactive monitoring system detects a match rule that needs review. ScoreStandalone and scoreIncremental elements may be used to calculate a Match Score for a profile that is designated as a potential match and can assist a data steward when reviewing potential matches.

Relevance-based matching is designed primarily as a replacement of the strategy that uses automatic and suspect rule types. With Relevance-based matching, the client may create a scoring algorithm of the user's own design. The advantage is that in most cases, a strategy based on Relevance-based matching can reduce the complexity and overall number of rules. The reason for this is that the two directives of merge and queue for review which normally require separate rules (automatic and suspect respectively) can often be represented by a single Relevance-Based rule.

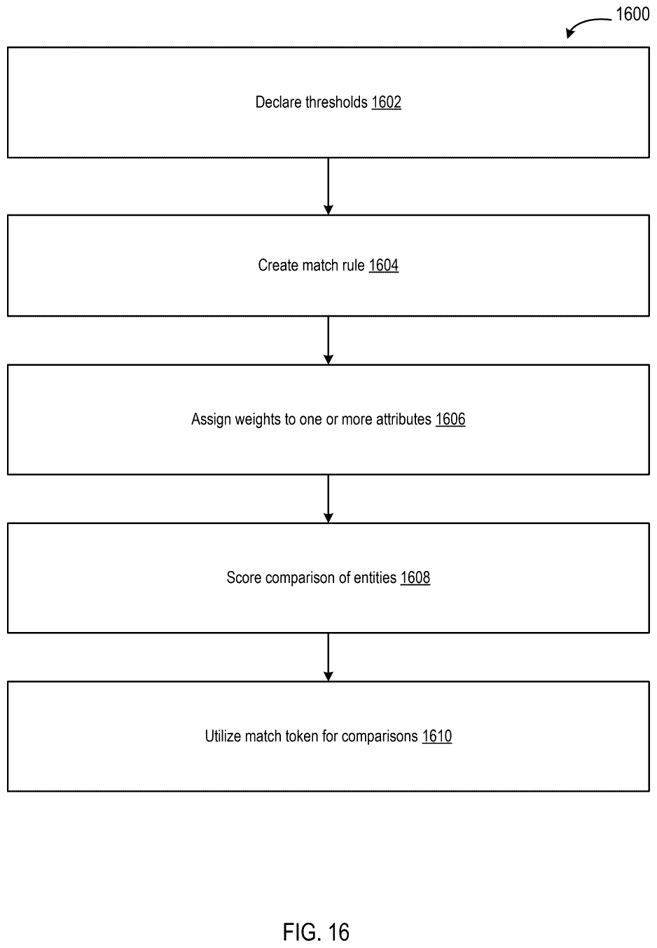

FIG. 16 depicts a dynamic matching flowchart. In this and other flowcharts, flow diagrams, and/or sequence diagrams, the flowchart illustrates by way of example a sequence of modules. It should be understood that the modules may be reorganized for parallel execution, or reordered, as applicable. Moreover, some modules that could have been included may have been removed to avoid providing too much information for the sake of clarity and some modules that were included could be removed but may have been included for the sake of illustrative clarity.

In step 1602, thresholds may be defined. For example, when declaring the ranges for queue_for_review and auto_merge, the combination should span the entire available range of 0.0 to 1.0 with no gap and no overlap except that the upper endpoint for queue_for_review should equal the lower endpoint for auto_merge thus have a common touchpoint between them (for example, 0.0 to 0.6 for queue_for_review, and 0.6 to 1.0 for auto_merge). If the action Thresholds leave a gap, then any score falling within the gap will produce no action. Conversely, if the actionThresholds overlap (for example, 0.4 to 0.6 for queue_for_review, and 0.5 to 0.7 for auto_merge) and a score lands within the intersection (0.55 in our example) or on the touchpoint, the directive of queue_for_review takes precedence.

In step 1604, match rules are created. Using Relevance-based matching, the client could create a match rule that contains a collection of attributes to test as a group.

In step 1606, weights may be assigned to attributes to govern their relative importance in the rule. Weights can be set from 0.0 to 1.0. If the client does not explicitly set a weight for an attribute, it may receive a default weight of 1.0 during execution of the rule. For example, starting with all weights equal to 1.0 and perhaps start with actionThresholds of 0.0-0.5 for queue_for_review and 0.5-1.0 for auto_merge. Do some trial runs and examine the results. If too many obvious matches are being set to queue_for_review, then weights may be adjusted and the actionThresholds modified (e.g., to perhaps 0.0-0.7, and 0.7-1.0). The user may iterate and experiment until able to get optimized results with the data set.

In step 1608, score comparison of entities is performed. In step 1610, the relevance_based match rules use the match token classes in the same way as they are used in suspect and automatic match rules. However, the comparison of the two entities works differently. Every comparator class provides relevance value while comparing values. The relevance is in the range of 0 to 1. For example, BasicStringComparator returns 0 if two values are different. It returns 1 if two values are the identical. Fractional values can be a result of DistinctWordsComparator or other comparators. Every attribute has assigned weights according to the importance of the attribute. If the weight is not assigned explicitly then it is equal to 1 for the simple attributes or Maximum of the weights of sub-nested attributes for nested or reference attributes. If an attribute has multiple values, then the maximum value of relevance is selected.

In various embodiments, the following information describes participants of the formulae: RelevanceScoreAND—the relevance score of AND operand, the relevance score of the match rule; Nsimple—number of simple attributes (e.g., FirstName, LastName) participating in the AND operator directly; weighti—configured weight of i-th simple attribute; relevancei—calculated relevance of i-th simple attribute; Nnest—number of nested and reference attributes (e.g., Phone-no, Email-ID, Address) participating in the AND operator directly; weightj—configured weight of j-th nested or reference attribute; relevancej—calculated relevance of j-th nested/reference attribute; Nlogical—number of logical operands (For example, AND or OR) participating in the AND operator directly; relevancek—calculated relevance of k-th logical operand (the weight of a logical operand is fixed to 1; RelevanceScoreOR=max (relevance1, . . . , relevancei, . . . , relevanceN) relevancei—relevance of simple attribute, nested attribute, logical operand participating in the OR operand directly; RelevanceScoreNOT=1−RelevanceScoreAND,OR, exact, . . . (The relevance score of the NOT operand is equal to 1 minus the relevance score of the operand having this negation.)

In various embodiments, the following information describes participants of the formulae:

$${RelevanceScore}_{AND} = \frac{\begin{matrix}{\sum }_{i = 1}^{{N}_{simple}} {weight}_{i} \cdot {relevance}_{i} + \\ {\sum }_{j = 1}^{Nnest} {weight}_{j} \cdot {relevance}_{j} + {\sum }_{k = 1}^{{N}_{logical}} {relevance}_{k}\end{matrix}}{{\sum }_{i = 1}^{{N}_{simple}} {weight}_{i} + {\sum }_{j = 1}^{Nnest} {weight}_{j} + {N}_{logical}}$$

BasicStringComparator provides the relevance values and the score is calculated as follows: true for First Name; true for LastName; false for Suffix. The score is calculated as (1*1+1*1+0*1)/(1+1+1)=?=66. With a score of 0.66 the directive for this pair will be set to queue_for_review.

The example below shows the use of the verifyMatches API when using Relevance-based matching. Noteworthy items are relevance values appear for every attribute comparison and relevance for the entire rule; Match action name is shown if the relevance is within the corresponding threshold range, and null if it is not within any action Threshold range; Matched field will be true if the relevance is within any action Threshold range.

In the match group configuration, the user may define Weights and action Thresholds. The weight property allows the client to assign a relative weight (strength) for each attribute. For example, the user may decide that Middle Name is less reliable and thus less important than First Name.

The action Threshold allows the client to define a range of scores to drive a directive. For example, the user might decide that the match group should merge the profile pair if the score is between 0.9 to 1.0, but should queue the pair for review if the score falls into a lower range of 0.6 to 0.9.

The user can configure a relevance-based match rule with multiple action thresholds having the same action type but with a different relevance score range.

In the above example, the type is potential_match for two different action thresholds. The user can differentiate such thresholds by assigning appropriate labels. The user can generate potential matches with different labels based on the range of the relevance score that allows the user to differentiate between higher and lower relevance score matches. The user can resolve matches quickly based on the label. In the example above, based on the relevance score, some potential matches can be considered for merging directly while others must be reviewed before any action is taken. The results of the API to get potential matches and the external match API will contain a relevance value and a matchActionLabel corresponding to each of the action type configured under the action Threshold parameter. For more information, see Potential Matches API and External Match API.

Using operators like equals and notEquals prevents tokenization from generating tokens. These operators should not have an impact on tokenization, if we want to compare and conclude that even though address and/or email and/or phone are different, the remaining attributes match enough to take the score above the threshold.

In some embodiments, the following options equal, notEquals and in constraints: 1) strict (Boolean value with default=true): Allows the constraint to be skipped before the match tokens and relevance score are computed; 2) weight (decimal with default=0.0): Allows the constraint to participate in the relevance score calculation. (The two options and their default values ensure backward compatibility.)

An example of a formula to calculate relevance score is:

$$R = \frac{{\sum }_{i}^{N} {R}_{i}^{operand} \cdot {w}_{i}^{operand} + {\sum }_{i}^{N} {R}_{i}^{constraint} \cdot {w}_{i}^{constraint}}{{\sum }_{i}^{N} {w}_{i}^{operand} + {\sum }_{i}^{N} {w}_{i}^{constraint}}$$

The formulae have the following variables: Roperand—the relevance score of an operand (for example: exact, exactOrNull, exactOrAllNull, fuzzy, etc.); Rconstraint—the relevance score calculated for a constraint (for example: equals, notEquals, in); Woperand—configured weight for an operand; Wconstraint—configured weight for a constraint.

In at least some organizations, profiles are maintained across systems and there are instances where multiple records of the same profile exist. There may be inconsistencies in each record. In such cases, it would be beneficial to merge these records and maintain one record with the complete information. There are also instances where two profiles are related to each other.

There are certain match pairs that the user can configure such that the system can automatically take action on those. Other match pairs that require manual review are resolved using the Potential Match screen. Match rules and Match IQ (discussed herein) may be utilized to determine if two records are a match, not a match, or a potential match.

Match rules and Match IQ may be used to determine if two records are a match, not a match, or a potential match. The user can also use the Match Score to decide if a profile is a potential match. Based on predefined match rules, each potential match is given a Match Score and the higher the score, higher is the probability of it to be a potential match for the profile. In some embodiments, the Match Score of a potential match will have a value of more than 0 only if the standalone and incremental scores are configured for the match rules.

There may be instances when certain profiles, in spite of being a potential match, are excluded from the profile view due to these match rules. In such cases, the user can manually search by entering the search criteria in the “Search” field and include these profiles as potential matches.

The user may have the option of viewing the Potential Matches perspective in the classic mode or the new mode.

In various embodiments, Match IQ uses machine learning (ML) to simplify and accelerate the data matching process. With Match IQ, business users can easily create a model for matching the records, by simply selecting the entity type and related attributes, without or minimum IT help. They can then train the ML model with the active learning process by reviewing pairs of records and indicating which are a match and which are not. As users confirm the matches, machine learning adjusts the matching model and presents additional record pairs to further refine the model.

After a sufficient number of representative record pairs have been matched or not matched, the user can download and review the match results. A downloaded file may show a sample set of match results and a relevance score for each record pair. The higher the relevance score, the more likely the records match. If needed, the user can retrain the model by answering more questions or even creating an alternate model to compare the matching results.

After the results are satisfactory, the data steward or other user with approval authority can review, approve and publish the model to use with internal and/or external data. The user also provides publishing settings based upon the relevance score range—for example, to define that match pairs with a relevance score of 8 to 1 should be matched and merged.

The end-to-end process, driven and performed by business users, typically takes only a day or two to complete and produces the quality matches customers require. In some embodiments, Match IQ uses machine learning technology to help ensure unified and reliable data across virtually unlimited data sources. The ML matching model, created with active learning using resolutions of suspected matched pairs, can be effectively applied to future match pairs. This provides a consistent way for business users and data stewards to match and merge data for increased quality, reliability, and business value.

Once a matching model is trained, no user interaction is required but the model can be retrained if needed. Because match and merge operations are performed using these models and calculated relevance scores, the process is rapid, consistent, and reliable. As the business grows or changes, the models can easily be adjusted to accommodate additional data sources. This enables matching and merging at the scale and speed of business.

The streamlined matching process, which does not require IT specialists or coding, enables customers to get up and running faster and with less effort. Typically, they can progress from initial subscription to completing their match-and-merge operations in a matter of days. Compare this to the weeks or months required by more traditional approaches. This same process is used to perform matching for new data sources as they are added, providing additional time savings and increased productivity.

No definition of matching requirements is needed; instead, users select matched pairs and machine learning creates the models. This greatly reduces the possibility of matching requirements not being correctly identified that might generate incorrect matches or miss valid matches. In addition, because machine learning creates and adjusts the matching model without configuration by IT specialists, coding errors are a thing of the past. This not only reduces errors in the match-and-merge process, but it also saves significant time as it creates a repeatable process. Customers have an option to use both Match IQ and traditional rule-based matching together if needed.

With all the time saved by using Match IQ, those involved-data owners, data stewards, IT and other business users-will find they have more time available for work that adds value to the business. They can use their time to focus on creating better user experiences, data improvement initiatives or streamlining other processes.

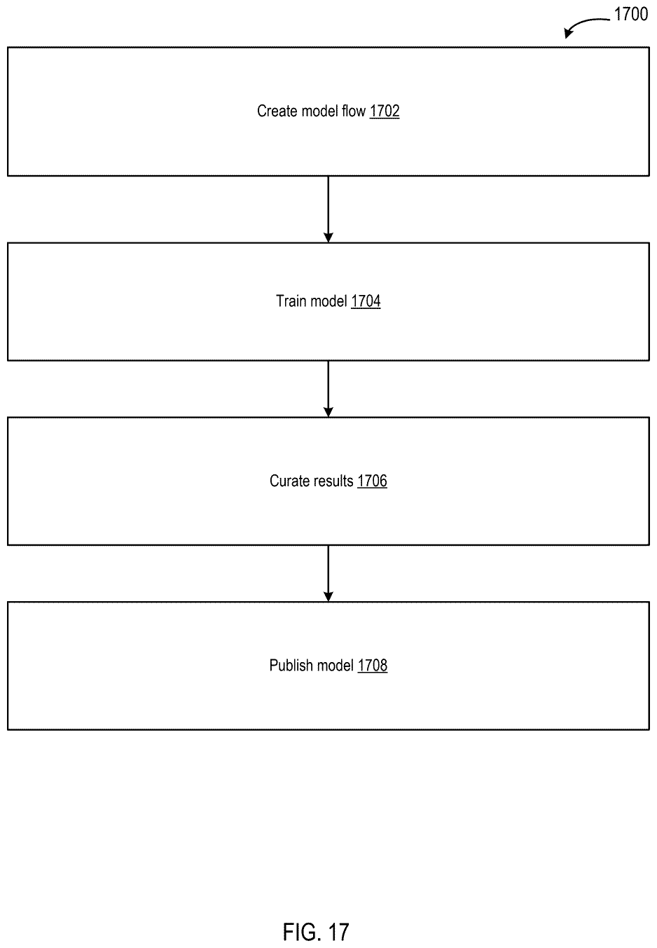

FIG. 17 depicts a high level flowchart for MatchIQ in some embodiments. In this and other flowcharts, flow diagrams, and/or sequence diagrams, the flowchart illustrates by way of example a sequence of modules. It should be understood that the modules may be reorganized for parallel execution, or reordered, as applicable. Moreover, some modules that could have been included may have been removed to avoid providing too much information for the sake of clarity and some modules that were included could be removed but may have been included for the sake of illustrative clarity.

In step 1702, the first step is to create a model flow by selecting entity types and attributes. In various embodiments, a graphical user interface may enable a user to select attributes to train the model (e.g., with a check system).

In step 1704, the model is trained. When the user trains a model, the user identifies records as matches or non-matches (e.g., by answering a series of questions). After the completion of the Preparing Data stage, the model moves under the Training lane. At this stage, the model is ready for training. There can be variations where records are neither close to matches nor non-matches. Such records then become the input to the training process where the user may be prompted with questions seeking confirmation on whether a particular pair is a match or not.

A machine learning methodology may be utilized. For example, a neural network may be utilized for training. Alternately, as other examples, gradient boosted decision trees or random forests may be utilized.

In step 1706, results are curated. In various embodiments, the graphical user interface may display details related to the model and results may be displayed (e.g., downloaded). Matches may be run and reviewed by the user to curate the results for further training and model improvement.

In step 1708, the user may publish the model. The user may choose to publish the model for internal and external matching. In some embodiments, the user may select external or internal.

For example, if the user selects external, the model may be used to match data from an external file with the data in the tenant. If the user selects internal, the model may be used to match the data within your tenant along with the match rules configured for the tenant.

In various embodiments, the user may define a custom action and a corresponding relevance score range. This allows the user to execute custom actions for relevance scores that are received for relevance-based rules. If a match pair falls within the defined range, then the custom action is executed. In a specific implementation, the relevance score range the user specifies for one action cannot overlap with the relevance score of another custom action.

In various embodiments, survivorship and merging are separate concepts and processes. Again, think of an entity as a container of crosswalks and their associated attributes and values. A merged entity may be an aggregation of crosswalks from two or more entities. The additional crosswalks continue to bring their own attributes and values with them. If the acquiring (winning) entity already has the same attribute URI that the incoming entity is bringing, then the values from the attributes will accumulate within the attribute, yet the integrity of which crosswalk each value within the attribute came from is maintained for several purposes including the need to return the attribute and its values to the original entity it came from if an unmerge is requested. If the acquiring entity does not already have the same attribute URI that the incoming entity is bringing, then the new attribute URI becomes established within the entity.

In some embodiments, unlike other MDM systems, survivorship is a separate process that doesn't occur during the merge. It is a process that executes in real time when the entity is being retrieved during an API call. Survivorship may not depend on how the crosswalks and attributes came into the consolidated profile nor the order that they arrived. Survivorship processes each attribute according to the attribute's defined survivorship rule, and produces an Operational Value (OV) for the attribute on-the-fly. Depending on the type of survivorship rule selected, there could be one or more OVs for an attribute. For example, the user might choose the aggregation rule for the address attribute for the purpose of returning all addresses a person is related to. Conversely the user might choose the frequency rule for “first name” to return the one name that occurs most frequently in the “first name” attribute. Note also that the role of the username making the API call also factors into the survivorship rule used. This feature allows one survivorship rule for an attribute to be stored with one username role, while another survivorship rule for the same attribute is stored with another username role. A fetch of the entity by each username role might return different OVs.

When configuring the survivorship rules for the attributes of an entity type, the user can do this largely from the UI, but there are some advanced survivorship strategies that may be defined through metadata configuration.

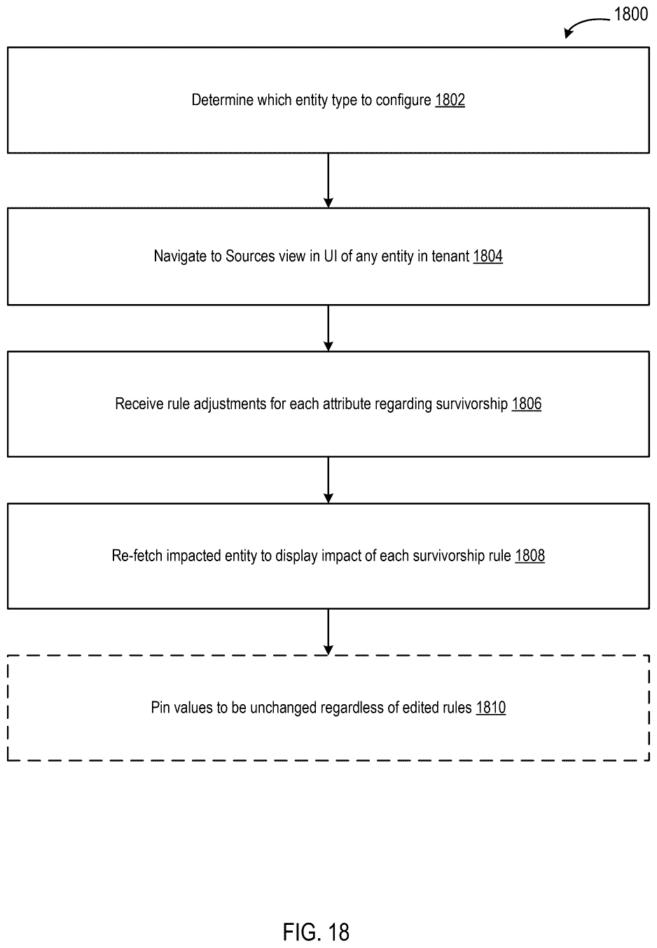

FIG. 18 depicts a flowchart for configuring survivorship within an example UI in some embodiments. In this and other flowcharts, flow diagrams, and/or sequence diagrams, the flowchart illustrates by way of example a sequence of modules. It should be understood that the modules may be reorganized for parallel execution, or reordered, as applicable. Moreover, some modules that could have been included may have been removed to avoid providing too much information for the sake of clarity and some modules that were included could be removed but may have been included for the sake of illustrative clarity.

When configuring survivorship via the UI, the user may not use the UI Modeler or Data Modeler. To configure attribute value survivorship via the UI, in step 1802, the user may determine which entity type to configure, then they may navigate to the Sources view of any actual entity in the tenant in step 1804. It may not matter which entity that is selected but it is recommended that the user pick one that has been sufficiently merged and thus has enough crosswalks (and thus raw values in its attributes) so that the user may witness material effects on-the-fly as they modify the survivorship rules.

In step 1806, in the Sources view while editing the survivorship for each attribute, the user can instantly see the effect on the screen in step 1808, which may guide the user. After you make a rule adjustment, the entity is fetched again using your new version of the rule and so you see the effect instantaneously.

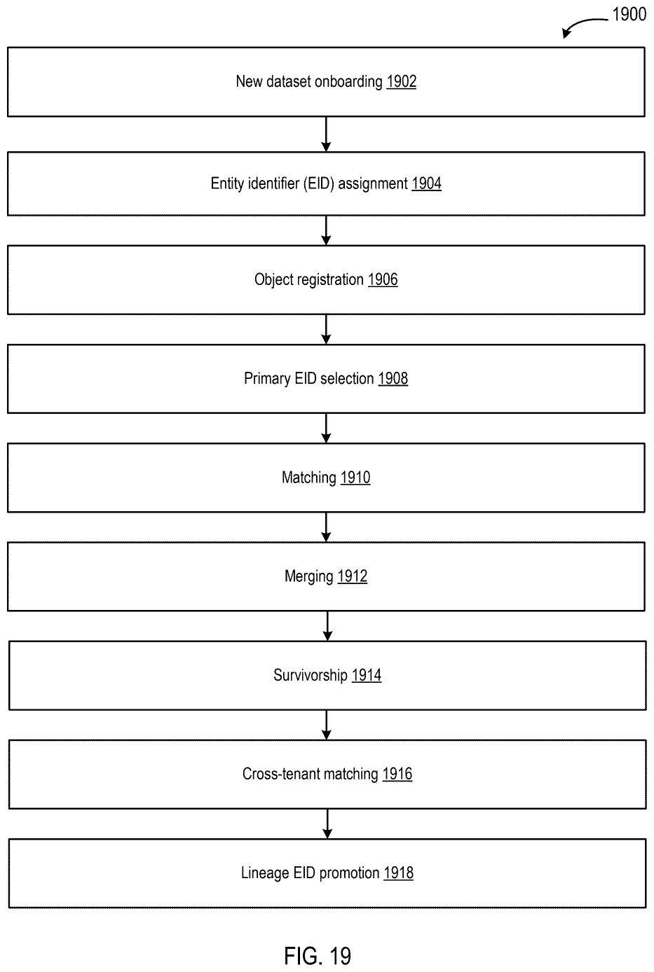

FIG. 19 depicts a flowchart of an example of a method of cross-tenant matching and lineage EID promotion. In this and other flowcharts, flow diagrams, and/or sequence diagrams, the flowchart illustrates by way of example a sequence of modules. It should be understood that the modules may be reorganized for parallel execution, or reordered, as applicable. Moreover, some modules that could have been included may have been removed to avoid providing too much information for the sake of clarity and some modules that were included could be removed but may have been included for the sake of illustrative clarity.

The flowchart 1900 starts at module 1902 with new dataset onboarding. New dataset onboarding is described above with reference to a dataset onboarding engine, which can carry out the process. Like the other engines described herein, the dataset onboarding engine may be a component of one or more regional platform instances.

The flowchart 1900 continues to module 1904 with EID assignment. EID assignment can be performed using an EID assignment engine. Like the other engines described herein, the EID assignment engine may be a component of one or more regional platform instances.

The flowchart 1900 continues to module 1906 with object registration. Object registration can be performed by an object registration engine. Like the other engines described herein, the object registration engine may be a component of one or more regional platform instances.

The flowchart 1900 continues to module 1908 with primary EID selection. Primary EID selection would occur naturally for a new object that has only one EID, but for objects that are merged, a primary EID is selected. A primary EID selection engine can carry out the process. Like the other engines described herein, the primary EID selection engine may be a component of one or more regional platform instances.

The flowchart 1900 continues to module 1910 with matching. Matching refers to the matching of objects in a datastore, such tenant datastores and/other datastores or systems. Because of a continuous process of integrating objects into the datastore(s), at some point an attempt at matching is likely to be made for every object that is onboarded, which may or may not result in a match. A matching engine can carry out the process. Like the other engines described herein, the matching engine may be a component of one or more regional platform instances.

The flowchart 1900 continues to module 1912 with merging. Merging refers to finding two objects that represent a common real world entity. A merging engine can carry out the process. Not all objects that are onboarded will necessarily be merged with other objects. Accordingly, the module 1912 could be skipped. Like the other engines described herein, the merging engine may be a component of one or more regional platform instances.

The flowchart 1900 continues to module 1914 with survivorship. Survivorship refers to, among other things, the technique of persisting EIDs. A survivorship engine can carry out the process. Not all objects that are onboarded will necessarily be merged, thereby triggering the survivorship, so the module 1914 could be skipped. Like the other engines described herein, the survivorship engine may be a component of one or more regional platform instances.

The flowchart 1900 continues to module 1916 with cross-tenant matching. Cross-tenant matching refers to the ability of a first tenant to use a first EID (or agent of the cross-tenant durable EID lineage-persistent RDBMS or other party that is given access) to match an object with a second EID at a second tenant. A cross-tenant matching engine, which can carry out the process, in part, by recognizing objects in two different tenants are associated with the same real world entity. It is not necessary for there to be actual cross-tenant matching for the flowchart 1900 to continue to module 1918. Like the other engines described herein, the cross-tenant matching engine may be a component of one or more regional platform instances.

The flowchart 1900 ends at module 1918 with lineage EID promotion. For example, a lineage EID promotion engine, which can carry out the process, in part, by persisting lineage EIDs and enables unmerging of objects in real time, without taking a datastore of the cross-tenant durable EID lineage-persistent RDBMS offline, at which point the flowchart 1900 can resume at one of several of the modules 1902-1918. Like the other engines described herein, the lineage EID promotion engine may be a component of one or more regional platform instances.

1. A system comprising:
one or more processors; and
memory storing instructions that, when executed by the one or more processors, cause the system to perform:
receiving, by a multi-tenant platform, a segment query, wherein the segment query includes static attributes and dynamic attributes, wherein the dynamic attributes include interaction data;
executing, by the multi-tenant platform, the segment query;
receiving, by the multi-tenant platform in response to the execution of the segment query, a segment result set, wherein the segment result set comprises a segment of a population of a tenant of the multi-tenant platform;
automatically synchronizing, by the multi-tenant platform in response to receiving the segment result set, the segment result set with one or more third-party systems;
triggering, in response to the automatic synchronization, the one or more third-party systems to perform one or more campaign actions of a campaign using the segment included in the segment result set;
storing the segment query;
receiving updated data for the static attributes and the dynamic attributes;
re-executing, either periodically or on-demand, the stored segment query using the updated data for the static attributes and the dynamic attributes;
receiving, by the multi-tenant platform in response to the re-execution of the stored segment query, a second segment result set, wherein the second segment result set comprises a second segment of the population of the tenant of the multi-tenant platform;
automatically synchronizing, by the multi-tenant platform in response to receiving the second segment result set, the second segment result set with the one or more third-party systems;
triggering, in response to the automatic synchronization, the one or more third-party systems to perform one or more second campaign actions using the second segment included in the second segment result set.

2. The system of claim 1, wherein the static attributes includes identification information.

3. The system of claim 2, wherein the identification information includes any of name, address, phone number, company, demographic information, and psychographic information.

4. The system of claim 1, wherein the interaction data includes how a tenant of the multi-tenant platform interacts with the multi-tenant platform.

5. The system of claim 4, wherein the interaction data includes one or more indications of any of the tenant opening an email and the tenant applying a software update.

6. A method comprising:
receiving, by a multi-tenant platform, a segment query, wherein the segment query includes static attributes and dynamic attributes, wherein the dynamic attributes include interaction data;
executing, by the multi-tenant platform, the segment query;
receiving, by the multi-tenant platform in response to the execution of the segment query, a segment result set, wherein the segment result set comprises a segment of a population of a tenant of the multi-tenant platform;
automatically synchronizing, by the multi-tenant platform in response to receiving the segment result set, the segment result set with one or more third-party systems;
triggering, in response to the automatic synchronization, the one or more third-party systems to perform one or more campaign actions of a campaign using the segment included in the segment result set;
storing the segment query;
receiving updated data for the static attributes and the dynamic attributes;
re-executing, either periodically or on-demand, the stored segment query using the updated data for the static attributes and the dynamic attributes;
receiving, by the multi-tenant platform in response to the re-execution of the stored segment query, a second segment result set, wherein the second segment result set comprises a second segment of the population of the tenant of the multi-tenant platform;
automatically synchronizing, by the multi-tenant platform in response to receiving the second segment result set, the second segment result set with the one or more third-party systems;
triggering, in response to the automatic synchronization, the one or more third-party systems to perform one or more second campaign actions using the second segment included in the second segment result set.

7. The method of claim 6, wherein the static attributes includes identification information.

8. The method of claim 7, wherein the identification information includes any of name, address, phone number, company, demographic information, and psychographic information.

9. The method of claim 6, wherein the interaction data includes how a tenant of the multi-tenant platform interacts with the multi-tenant platform.

10. The method of claim 9, wherein the interaction data includes one or more indications of any of the tenant opening an email and the tenant applying a software update.

11. A system comprising:
one or more processors; and
memory storing instructions that, when executed by the one or more processors, cause the system to perform:
obtaining, by a multi-tenant platform, one or more domain-specific machine learning models;
obtaining, by the multi-tenant platform, static attribute data and dynamic attribute data;
predicting, by the multi-tenant platform using the one or more domain-specific machine learning models and the static attribute data the dynamic attribute data, a response likelihood of one or more entities of a population of a tenant of the multi-tenant platform;
receiving, by a multi-tenant platform, a segment query, wherein the segment query includes static attributes and dynamic attributes, wherein the dynamic attributes include interaction data and the predicted response likelihood of the one or more entities of the population of the tenant of the multi-tenant platform;
executing, by the multi-tenant platform, the segment query;
receiving, by the multi-tenant platform in response to the execution of the segment query, a segment result set, wherein the segment result set comprises a segment of a population of a tenant of the multi-tenant platform;
automatically synchronizing, by the multi-tenant platform in response to receiving the segment result set, the segment result set with one or more third-party systems;
triggering, in response to the automatic synchronization, the one or more third-party systems to transmit one or more electronic messages to the segment included in the segment result set.

12. The system of claim 11, wherein the static attributes includes identification information.

13. The system of claim 12, wherein the identification information includes any of name, address, phone number, company, demographic information, and psychographic information.

14. The system of claim 11, wherein the interaction data includes how a tenant of the multi-tenant platform interacts with the multi-tenant platform.

15. The system of claim 14, wherein the interaction data includes one or more indications of any of the tenant opening an email and the tenant applying a software update.

16. A method comprising:
obtaining, by a multi-tenant platform, one or more domain-specific machine learning models;
obtaining, by the multi-tenant platform, static attribute data and dynamic attribute data;
predicting, by the multi-tenant platform using the one or more domain-specific machine learning models and the static attribute data the dynamic attribute data, a response likelihood of one or more entities of a population of a tenant of the multi-tenant platform;
receiving, by a multi-tenant platform, a segment query, wherein the segment query includes static attributes and dynamic attributes, wherein the dynamic attributes include interaction data and the predicted response likelihood of the one or more entities of the population of the tenant of the multi-tenant platform;
executing, by the multi-tenant platform, the segment query;
receiving, by the multi-tenant platform in response to the execution of the segment query, a segment result set, wherein the segment result set comprises a segment of a population of a tenant of the multi-tenant platform;
automatically synchronizing, by the multi-tenant platform in response to receiving the segment result set, the segment result set with one or more third-party systems;
triggering, in response to the automatic synchronization, the one or more third-party systems to transmit one or more electronic messages to the segment included in the segment result set.

17. The method of claim 16, wherein the static attributes includes identification information.

18. The method of claim 17, wherein the identification information includes any of name, address, phone number, company, demographic information, and psychographic information.

19. The method of claim 16, wherein the interaction data includes how a tenant of the multi-tenant platform interacts with the multi-tenant platform.

20. The method of claim 19, wherein the interaction data includes one or more indications of any of the tenant opening an email and the tenant applying a software update.
